(19) United States
(12) Patent Application Publication
(10) Pub. No.: US 2023/0297204 A1
(43) Pub. Date: Sep. 21, 2023

(54) TEMPORAL INFORMATION SYSTEMS

(71) Applicant: Gavin Burke, Oceanside, CA (US)

(72) Inventor: Gavin Burke, Oceanside, CA (US)

(21) Appl. No.: 18/108,462

(22) Filed: Feb. 10, 2023

Related U.S. Application Data
(63) Continuation-in-part of application No. 17/466,298, filed on Sep. 3, 2021.
(60) Provisional application No. 63/074,604, filed on Sep. 4, 2020.

(51) Int. Cl. G06F 3/0481

(52) U.S. Cl. CPC G06F 3/0481

(57) ABSTRACT

Temporal information is traversed and manipulated in response to user input and the advancement of time. A temporal sequence is traversed by a present or user-specified time and by upwards and downwards traversal. Temporal strings are populated with references to a present date. Calendars feature temporal information in accordance with the truth values of various statements.

### CROSS REFERENCE TO A RELATED APPLICATION

This patent application claims priority to a co-pending U.S. Utility patent application Ser. No. 17/466,298 filed Sep. 3, 2021 entitled “Temporal Information Systems” and U.S. Provisional Application entitled “Method and System for Fetching Activities in a Middle-Out Fashion Via a Telecommunications Network” Ser. No. 63/074,604 filed on Sep. 4, 2020, the entire contents of each of which are hereby incorporated by reference.

### TECHNICAL FIELD

This patent application relates generally to computation for traversing and manipulating temporal information.

### BACKGROUND

This patent application is directed to client- and server-side computation for traversing and manipulating temporal information. Its object is to advance the present state of temporal information systems.

### SUMMARY

The foregoing object is achieved in memory with instructions processed to traverse and manipulate temporal information in response to user input and the advancement of time. A temporal sequence is traversed by a present or user-specified time and by upwards and downwards traversal. Temporal strings are populated with references to a present date. Calendars feature temporal information in accordance with the truth values of various statements.

### BRIEF DESCRIPTION OF THE DRAWINGS

FIG. 1 illustrates client—server operations for temporal-sequence traversal by a present, specified, posterior, or anterior time;

FIG. 2A depicts an example sequence of temporal-information (“t.i.”) instances;

FIG. 2B illustrates conditions for the possibility of viewing specific instances of t.i.;

FIG. 2C also illustrates conditions for the possibility of viewing specific instances of t.i.;

FIG. 2D depicts hour- and minute-controller indicia for reaching the sequence of t.i. observed in FIG. 2E

FIG. 2E depicts a t.i. sequence resulting from events on the hour- and minute-controller indicia observed in FIG. 2D;

FIG. 2F depicts a calendar for reaching the sequence of t.i. observed in FIG. 2G;

FIG. 2G depicts a t.i. sequence resulting from events on the calendar observed in FIG. 2F;

FIG. 2H depicts a non-sorted permutation of t.i.;

FIG. 3A depicts a t.i. sequence featuring t.i. closest to a present time;

FIG. 3B also depicts a t.i. sequence featuring t.i. closest to a present time;

FIG. 3C also depicts a t.i. sequence featuring t.i. closest to a present time;

FIG. 4A depicts hour- and minute-controller indicia for reaching t.i. by a user-specified time;

FIG. 4B also depicts hour- and minute-controller indicia for reaching t.i. by a user-specified time;

FIG. 4C depicts hour- and minute-controller indicia for reaching the t.i. sequence observed in FIG. 4D;

FIG. 4D depicts a t.i. sequence resulting from events on the hour- and minute-controller indicia observed in FIG. 4C;

FIG. 4E depicts hour- and minute-controller indicia for reaching the t.i. sequence observed in FIG. 4F;

FIG. 4F depicts a t.i. sequence resulting from events on the hour- and minute-controller indicia observed in FIG. 4E;

FIG. 4G depicts hour- and minute-controller indicia for reaching the t.i. sequence observed in FIG. 4H;

FIG. 4H depicts a t.i. sequence resulting from events on the hour- and minute-controller indicia observed in FIG. 4G;

FIG. 5A depicts calendars for reaching t.i. by a user-specified date;

FIG. 5B also depicts calendars for reaching t.i. by a user-specified date;

FIG. 5C depicts a calendar for reaching the sequence of t.i. observed in FIG. 5D;

FIG. 5D depicts a t.i. sequence resulting from events on the calendar observed in FIG. 5C;

FIG. 5E depicts a calendar for reaching the sequence of t.i. observed in FIG. 5F;

FIG. 5F depicts a t.i. sequence resulting from events on the calendar observed in FIG. 5E;

FIG. 5G depicts a calendar for reaching the sequence of t.i. observed in FIG. 5H;

FIG. 5H depicts a t.i. sequence resulting from events on the calendar observed in FIG. 5G;

FIG. 6A introduces a temporal alphabet;

FIG. 6B gives the form of possible strings over the alphabet observed in FIG. 6A;

FIG. 6C specifies referential substrings that populate temporal strings in accordance with the date difference between a present date and the date of a t.i. instance;

FIG. 6D specifies example temporal strings;

FIG. 6E gives the form of possible strings in accordance with the date difference between a present date and the date of a t.i. instance;

FIG. 7A outlines the evolution of a temporal string as time advances;

FIG. 7B also outlines the evolution of a temporal string as time advances;

FIG. 7C also outlines the evolution of a temporal string as time advances;

FIG. 7D also outlines the evolution of a temporal string as time advances;

FIG. 7E also outlines the evolution of a temporal string as time advances;

FIG. 7F also outlines the evolution of a temporal string as time advances;

FIG. 7G also outlines the evolution of a temporal string as time advances;

FIG. 7H also outlines the evolution of a temporal string as time advances;

FIG. 7I also outlines the evolution of a temporal string as time advances;

FIG. 8A marks labels for opening or traversing a calendar;

FIG. 8B marks labels for atoms regarding whether there is posterior- or anterior-month t.i.;

FIG. 8C marks labels for commands for effacing posterior- and anterior-month indicia;

FIG. 8D specifies event—command—literal relations;

FIG. 8E marks labels for atoms regarding whether there is present-, future-, or past-month or date t.i.;

FIG. 8F marks labels for commands for displaying present-, future-, or past-month or date t.i.;

FIG. 8G specifies event—command—statement relations;

FIG. 8H illustrates a procedure for deciding whether to display a present, future, or past month upon opening a calendar;

FIG. 8I illustrates a procedure for deciding whether to display present-, future-, or past-date t.i. beside a calendar upon opening the calendar;

FIG. 8J illustrates a procedure for deciding whether to display posterior- or anterior-month-traversal indicia upon visiting some month in a calendar;

FIGS. 9A depicts calendars marked with statements that engender the temporal information they feature;

FIGS. 9B also depicts calendars marked with statements that engender the temporal information they feature;

FIGS. 9C also depicts calendars marked with statements that engender the temporal information they feature;

FIGS. 9D also depicts calendars marked with statements that engender the temporal information they feature;

FIGS. 10A depicts a calendar marked with statements that engender the temporal information it features;

FIGS. 10B also depicts a calendar marked with statements that engender the temporal information it features;

FIGS. 10C also depicts a calendar marked with statements that engender the temporal information it features;

FIGS. 10D also depicts a calendar marked with statements that engender the temporal information it features.

### DETAILED DESCRIPTION OF PREFERRED EMBODIMENTS

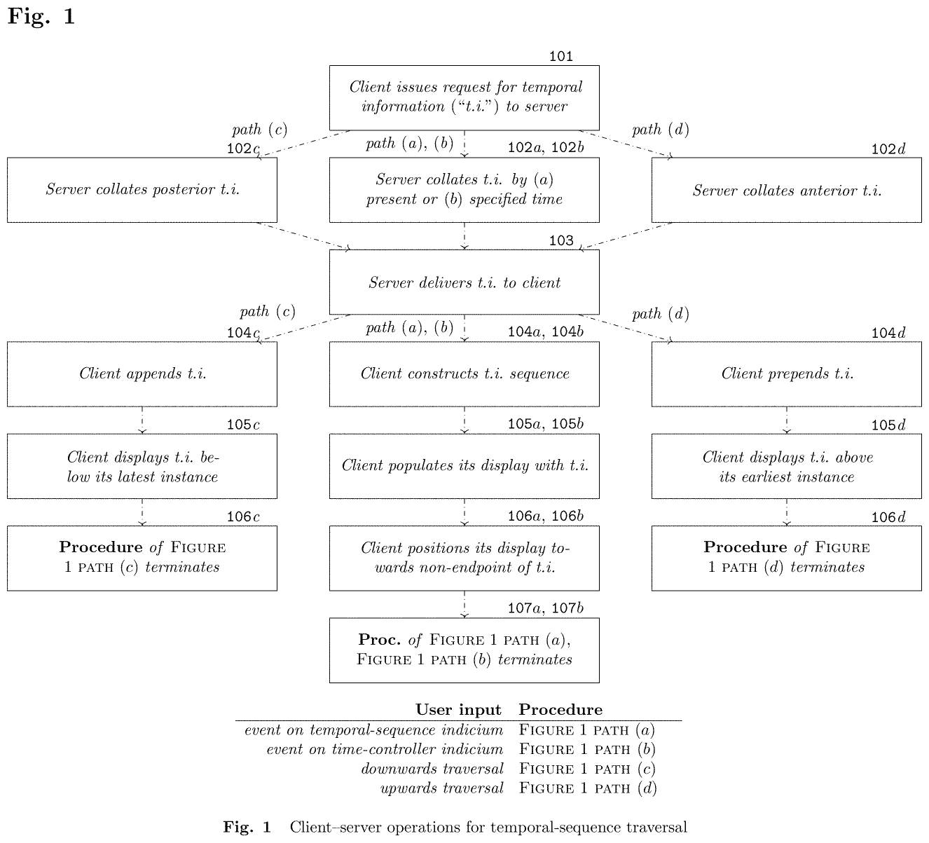

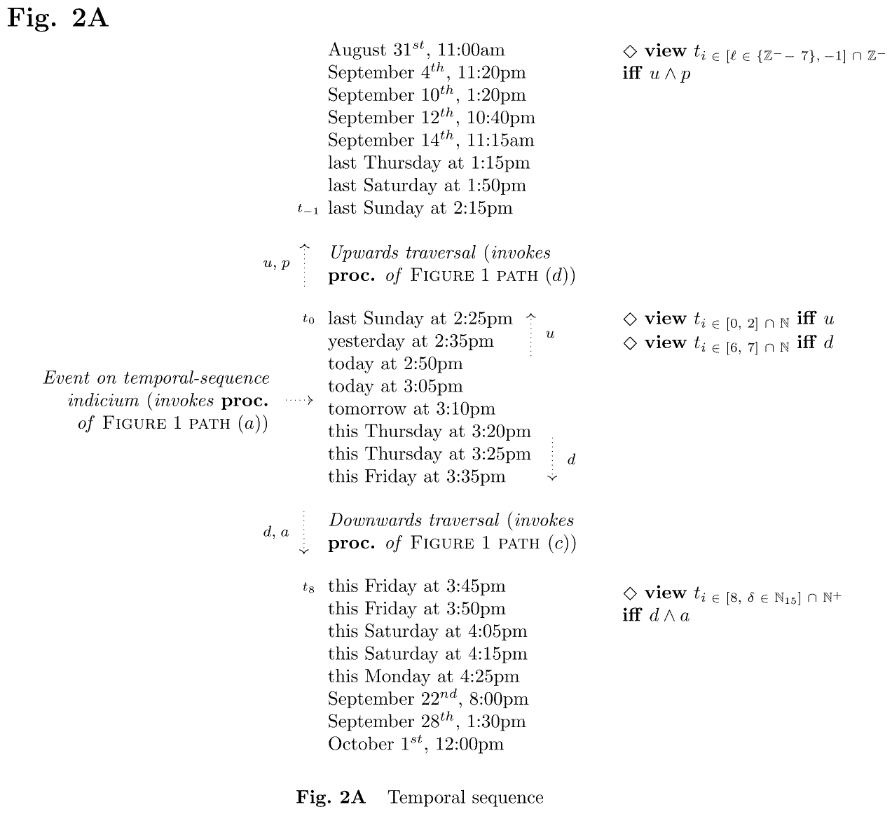

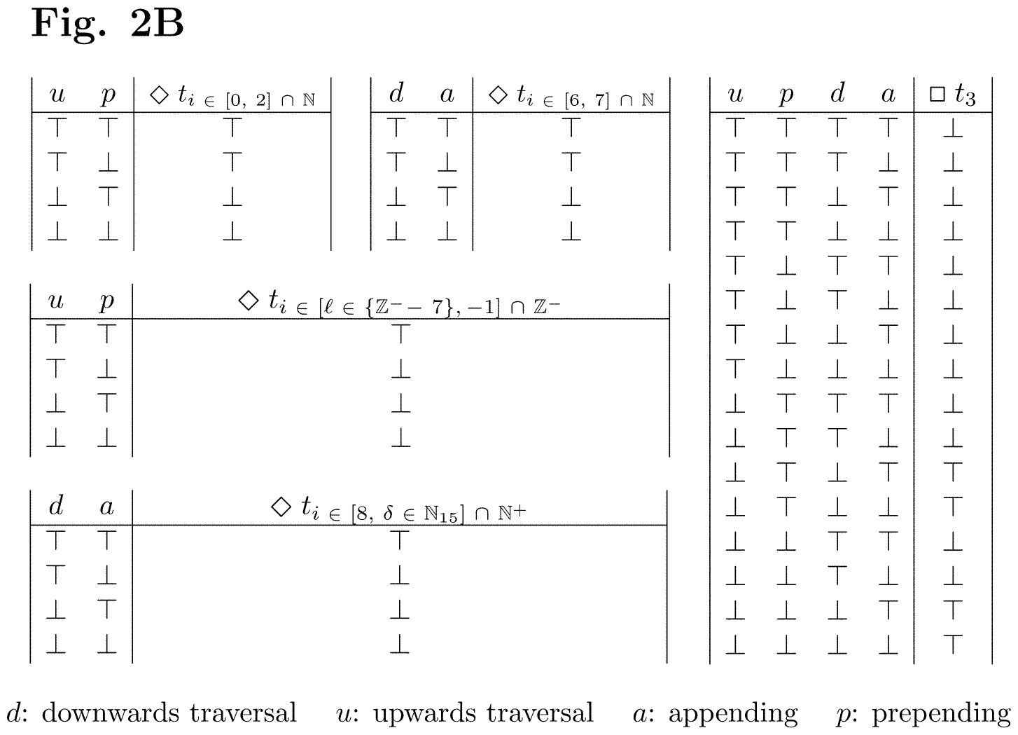

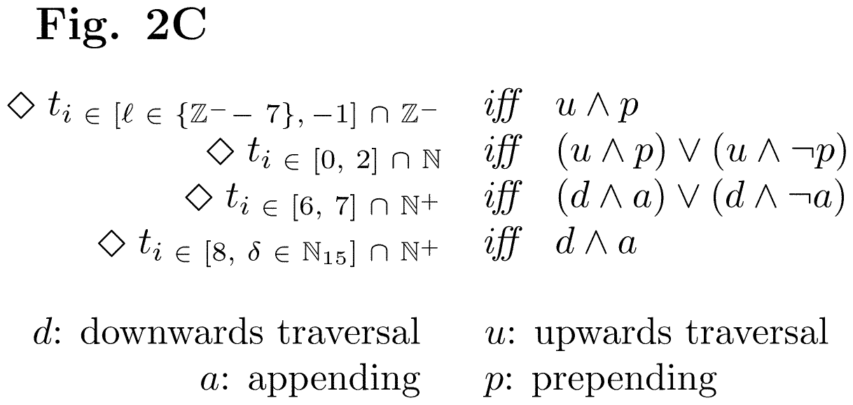

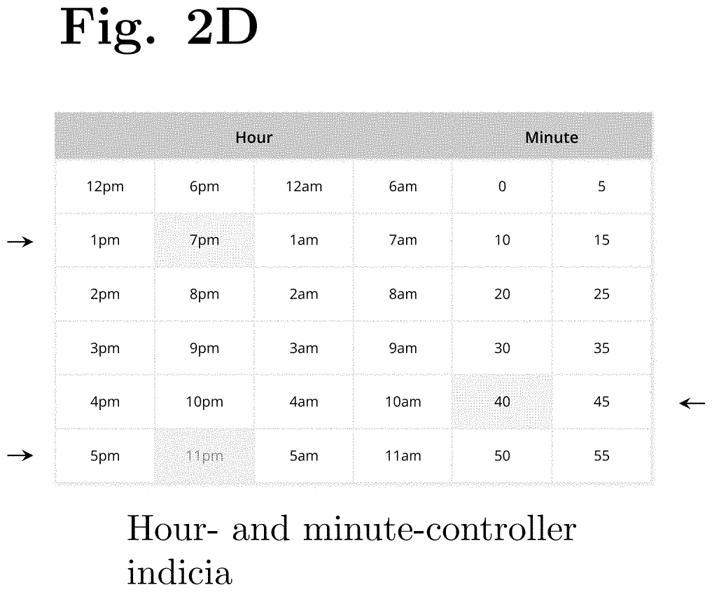

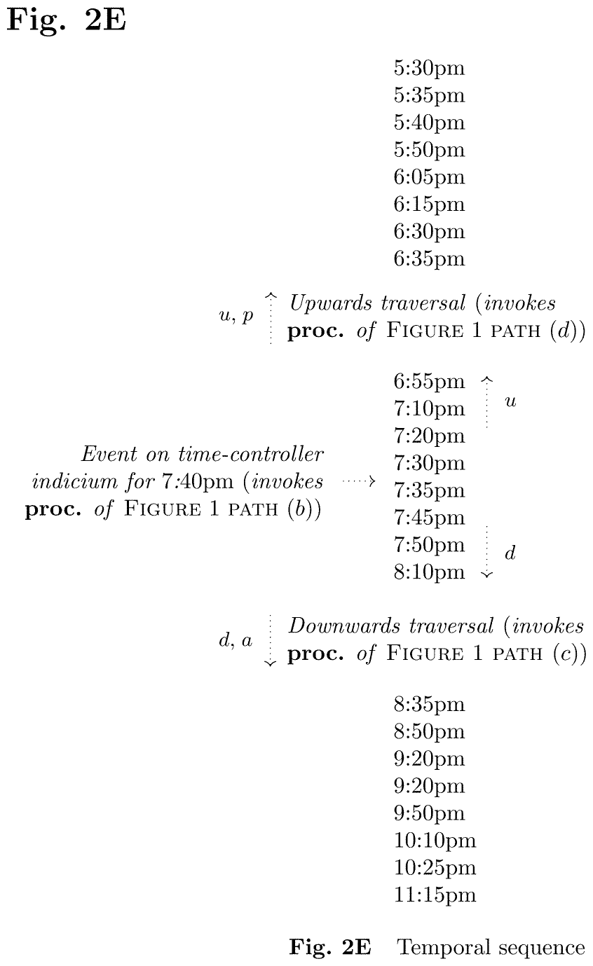

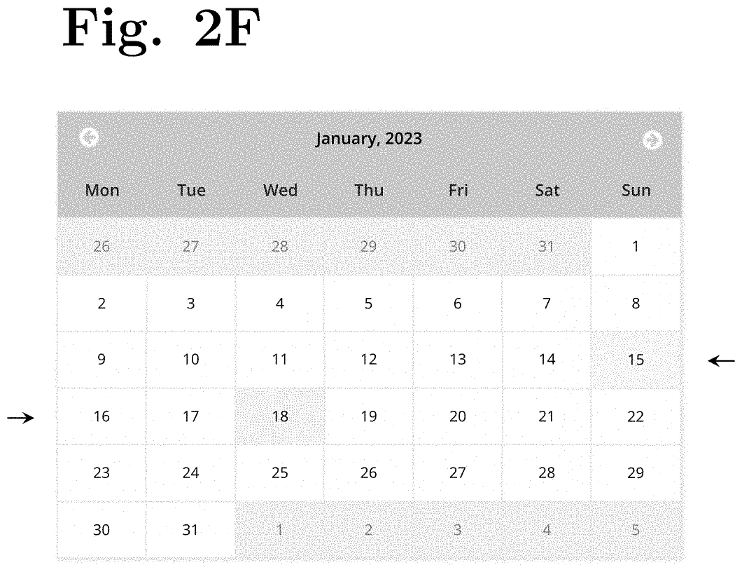

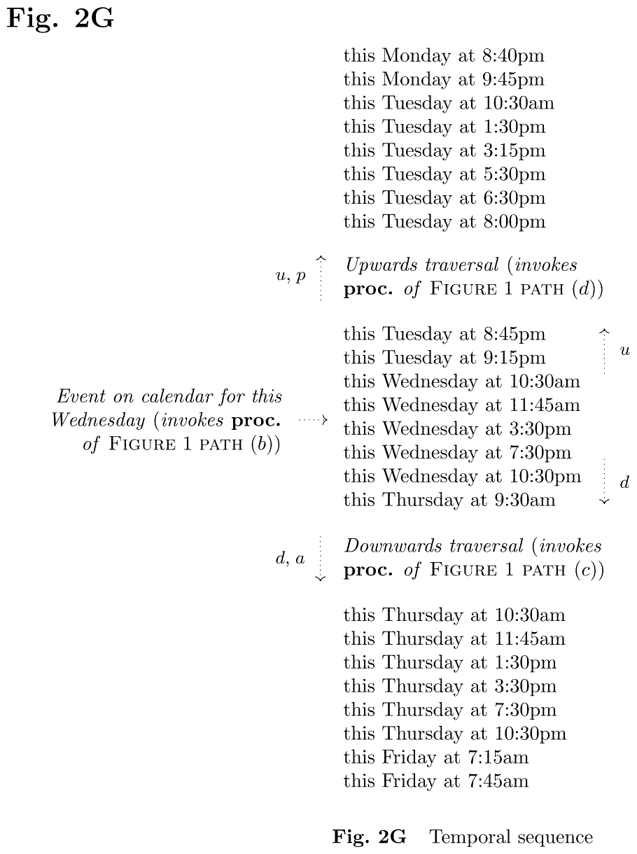

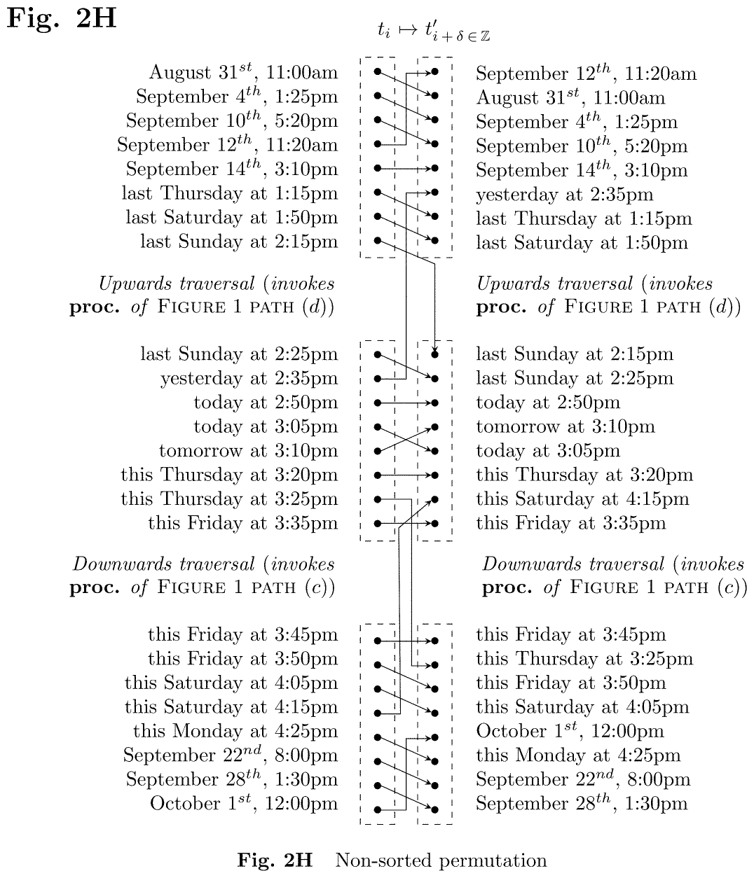

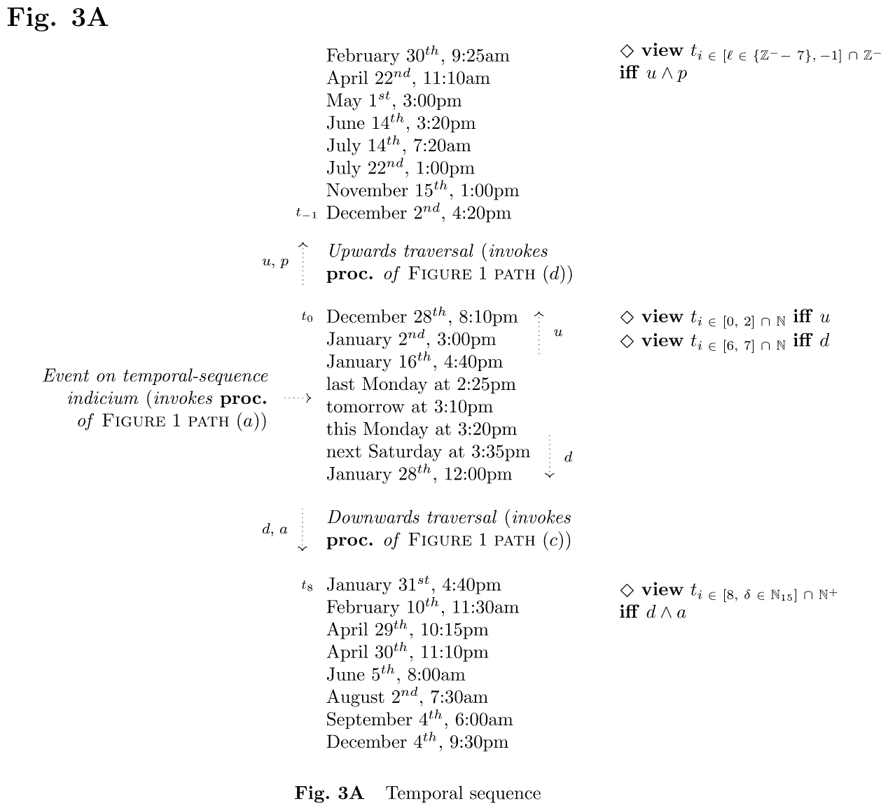

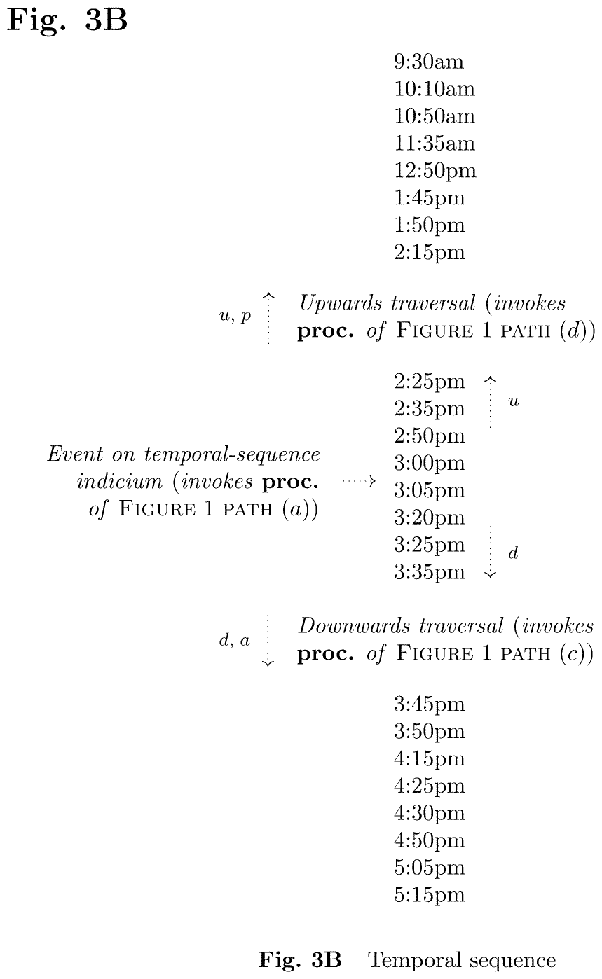

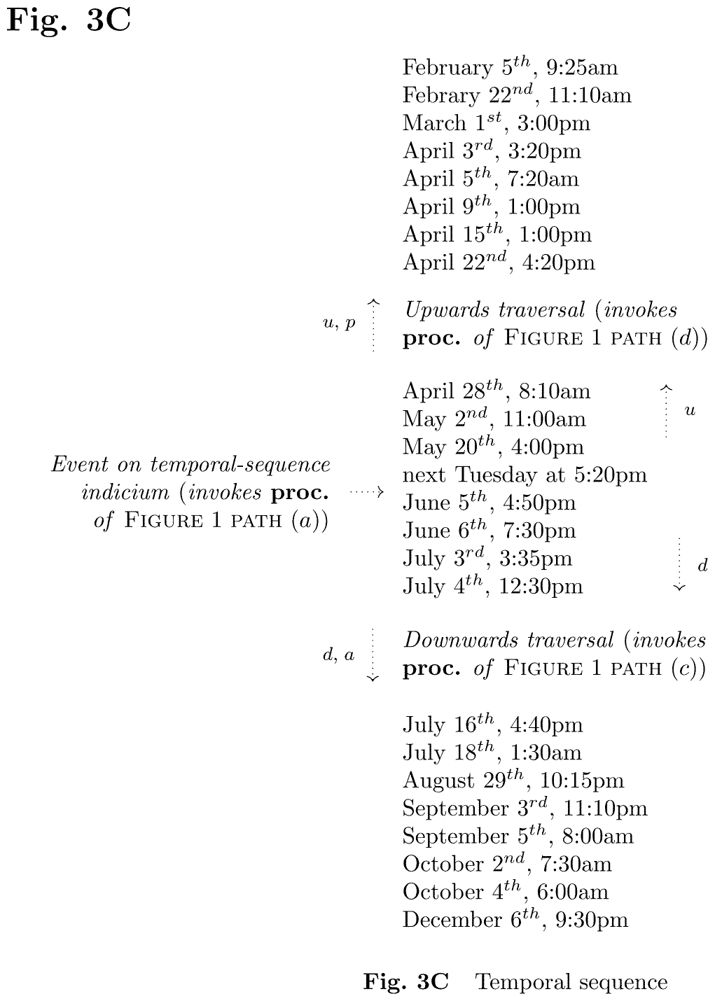

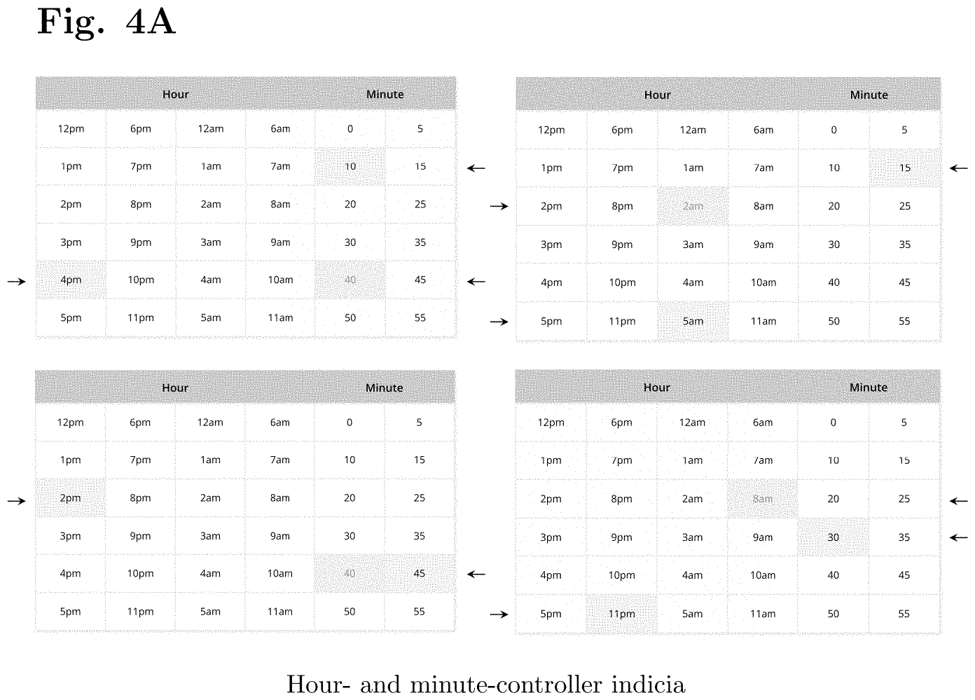

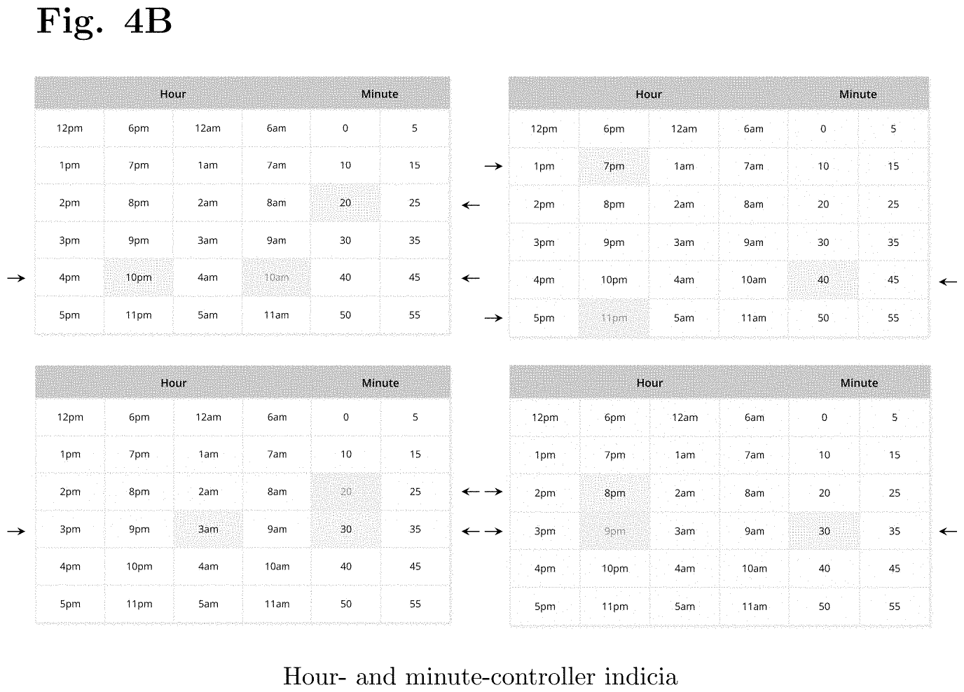

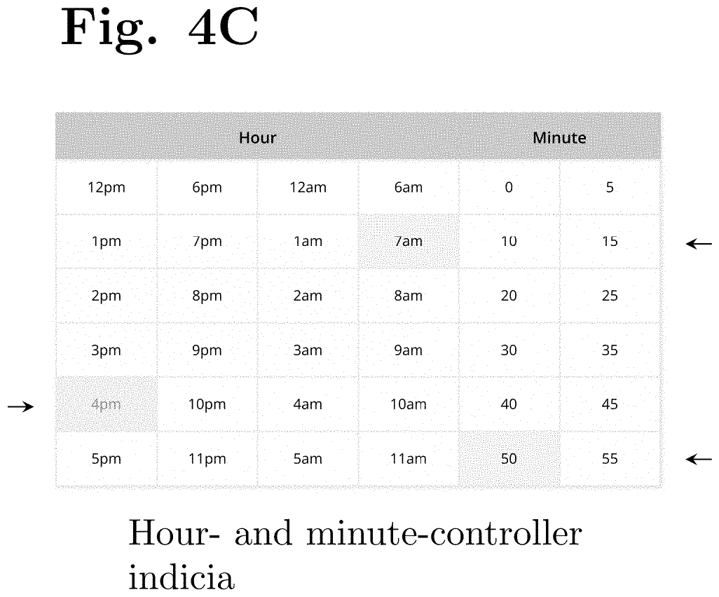

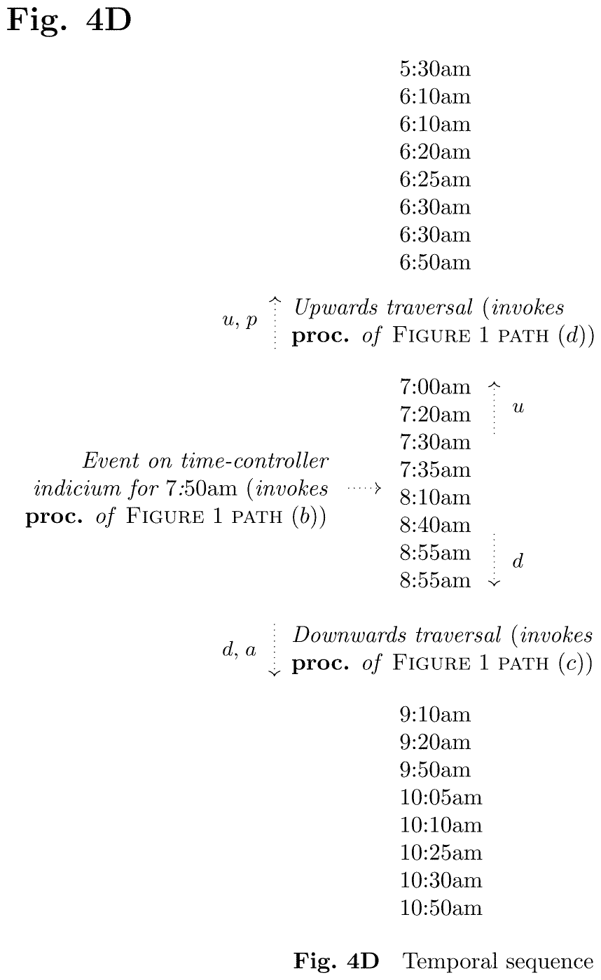

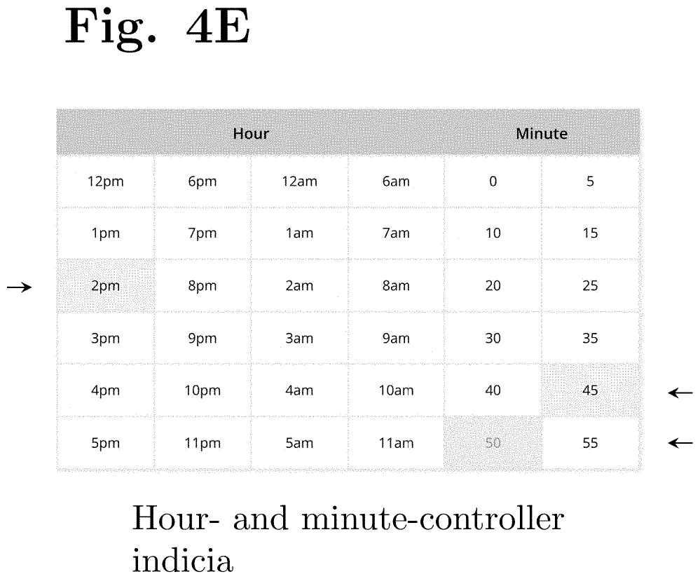

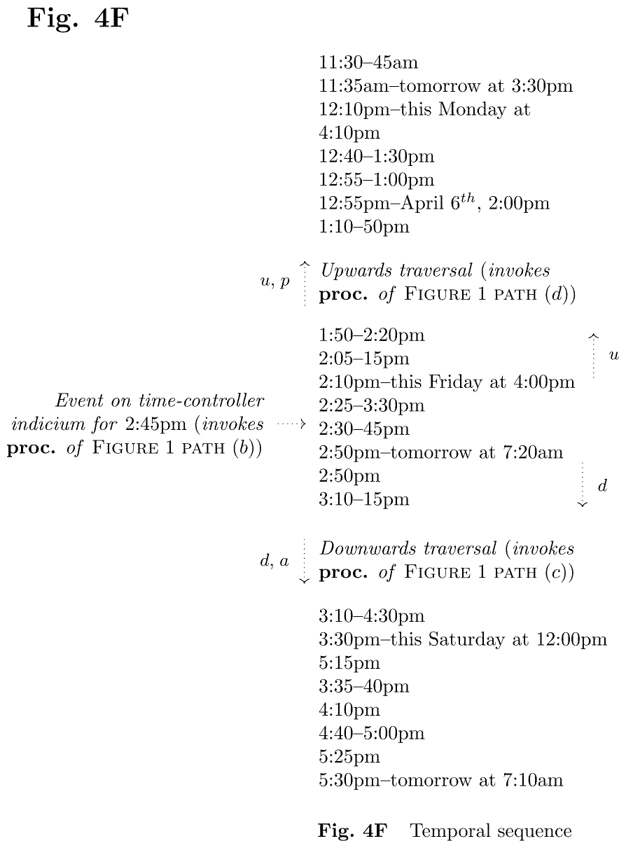

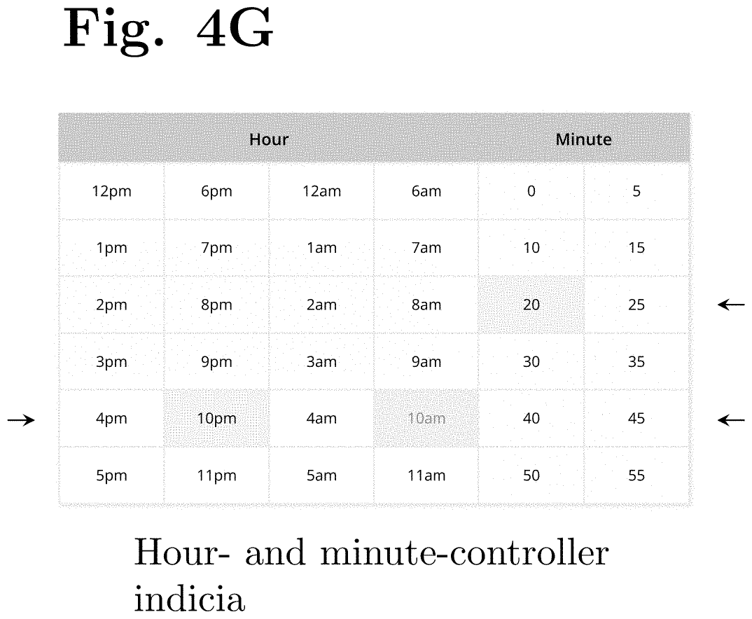

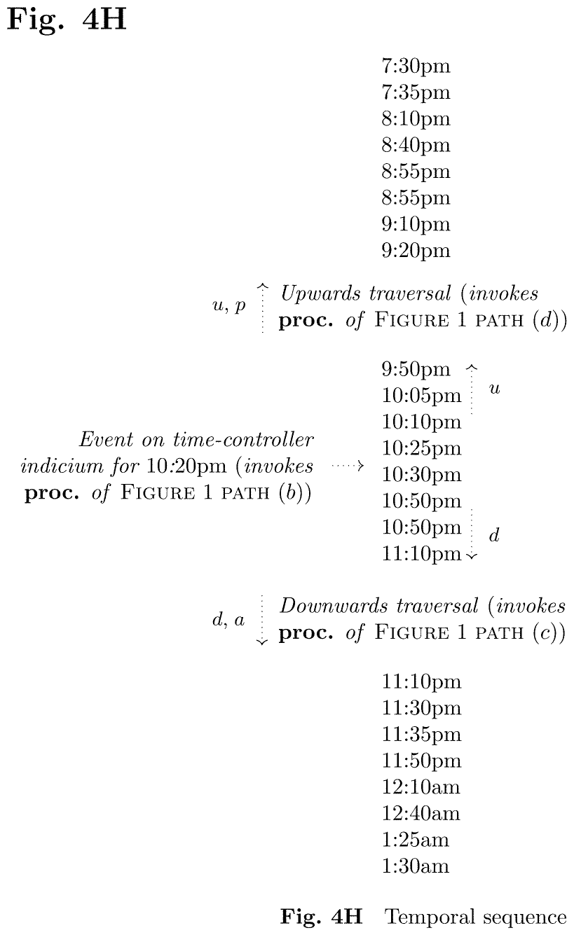

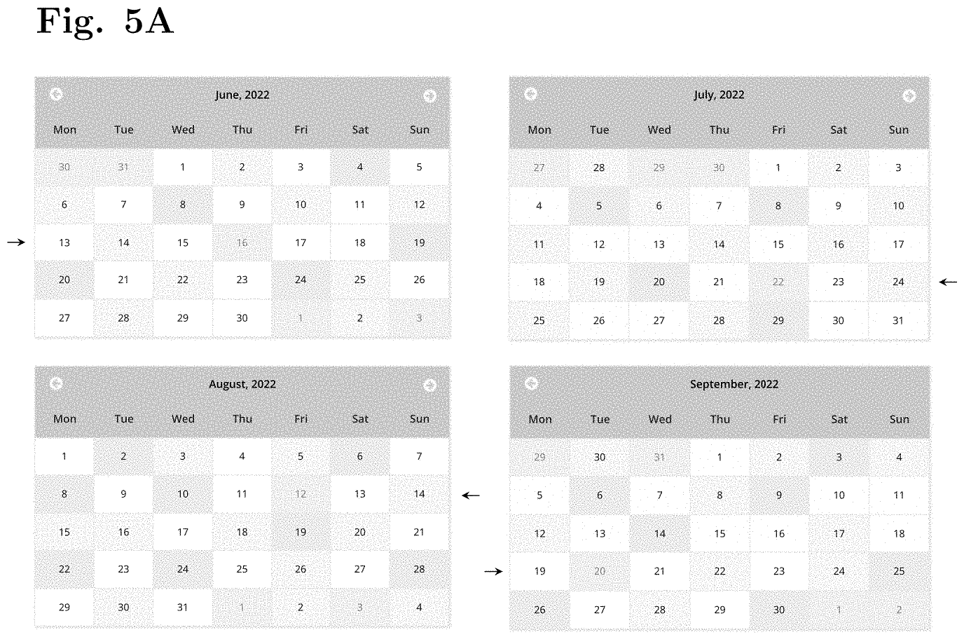

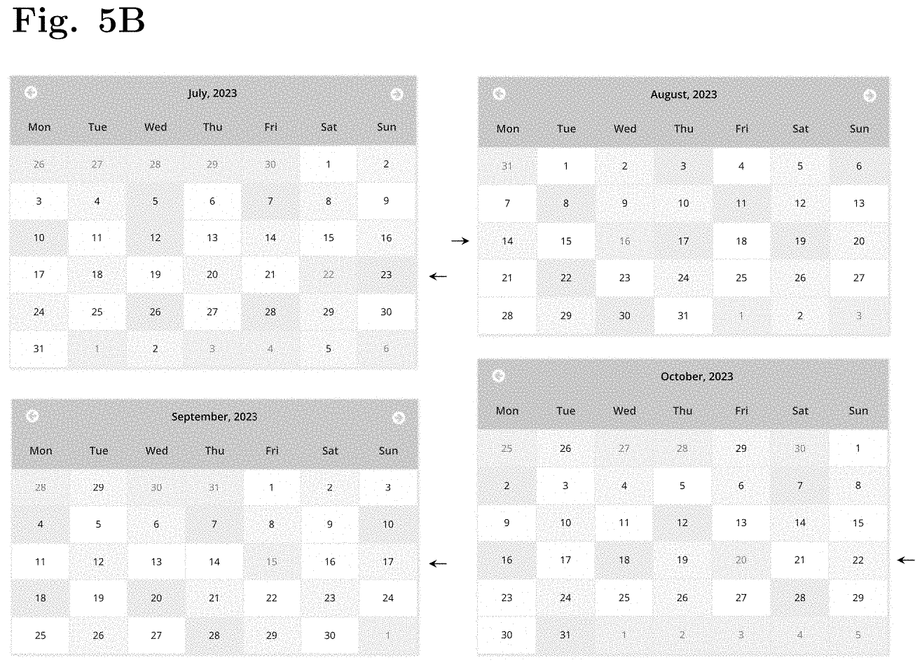

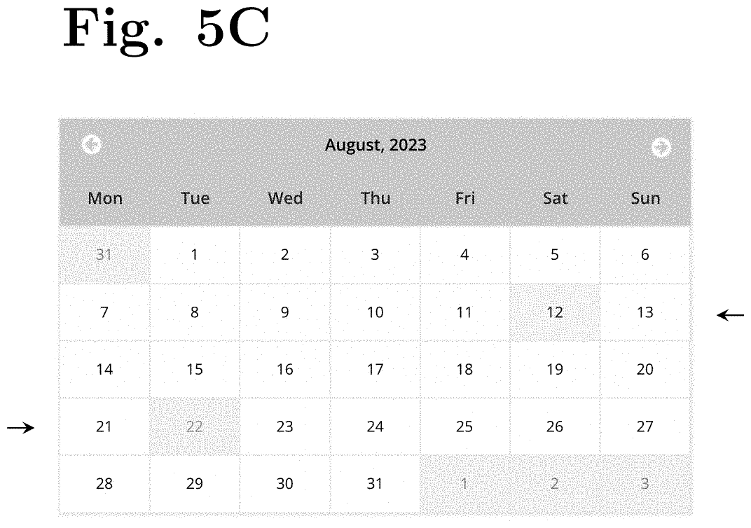

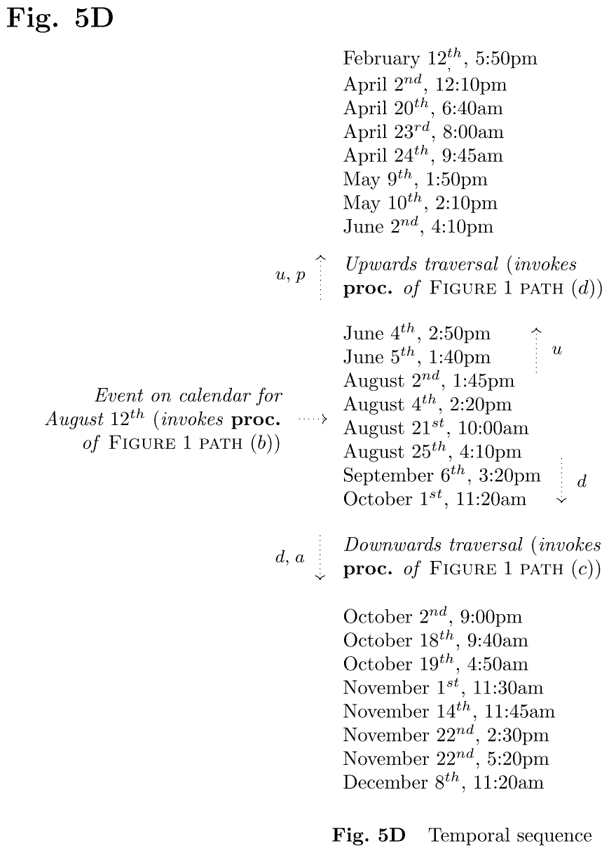

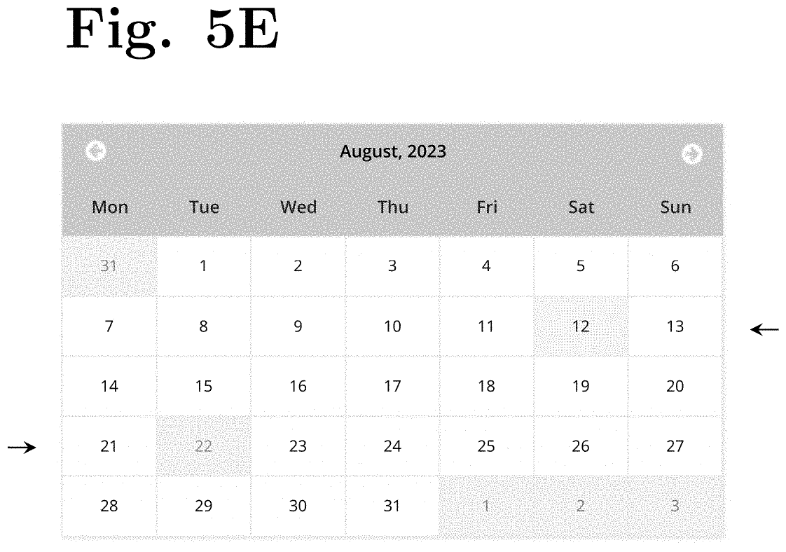

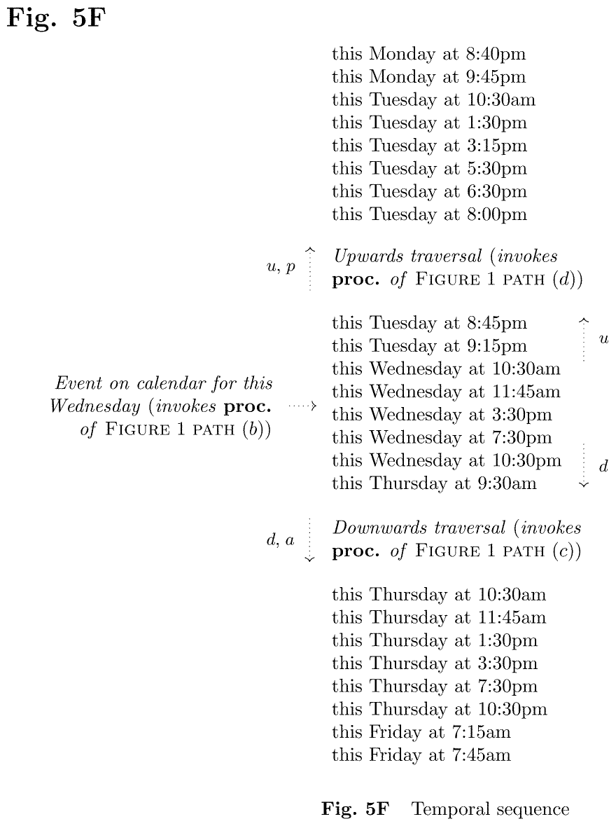

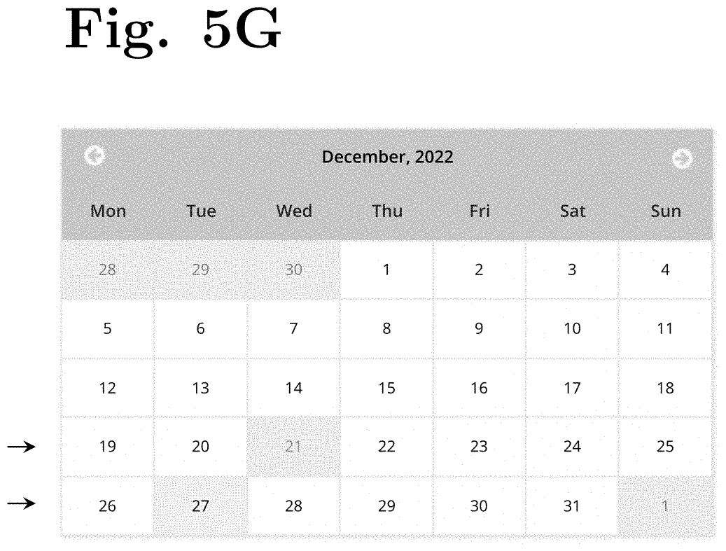

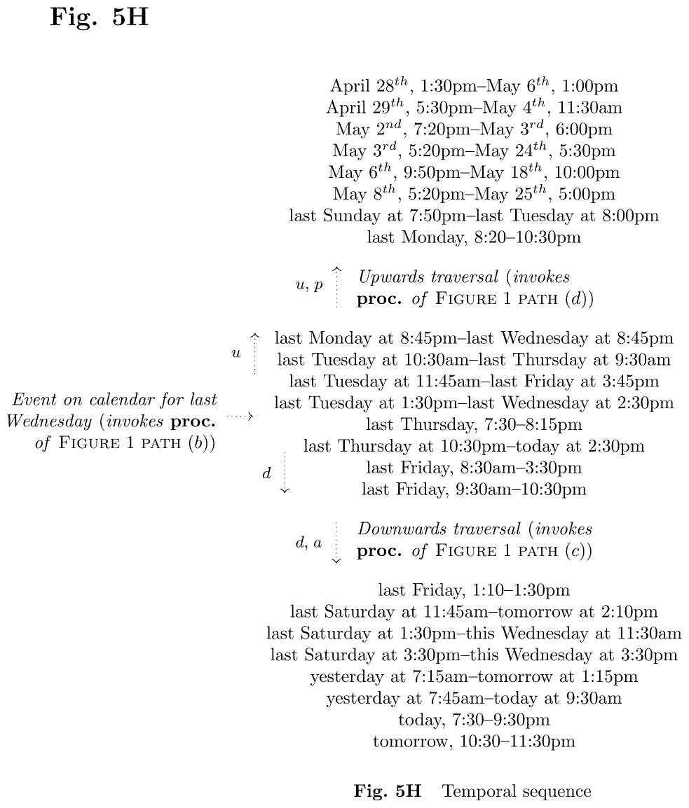

Four example execution paths for traversing a sequence of temporal information are shown diagrammatically in FIG. 1. The flow illustrates client-server operations for temporal-sequence traversal by either a present, a specified, a posterior, or an anterior time. User input invoking the four execution paths (procedures) is tabulated towards the bottom of FIG. 1.

These procedures respectively achieve invocation in response to an event on a temporal-sequence indicium (executing steps 101, 102a, 103, and 104-107a (referred to as “FIG. 1 path (a)”)); or an event on a time-controller indicium (executing steps 101, 102b, 103, and 104-7b (referred to as “FIG. 1 path (b)”)); downwards traversal (executing steps 101, 102c, 103, and 104-6c (referred to as “FIG. 1 path (c)”)); or upwards traversal (executing steps 101, 102d, 103, and 104-6d (referred to as “FIG. 1 path (d)”)).

More particularly, for the example path (a), in step 101, a client issues a request for temporal information (“t.i.”) to a server.

Next, in step 102a, the server collates from a database t.i. by a present time.

In step 103, the server delivers the t.i. to the client.

Next, in step 104a, the client constructs a t.i. sequence.

In step 105a the client then populates a display with the t.i.

In step 106a, the client positions the display towards a non-endpoint of the t.i.

Finally, in step 107a, path (a) terminates.

The procedure for path (b), invoked by an event on a time-controller indicium, is similar.

The procedure for path (c) is invoked by downwards traversal.

First, in step 101, a client issues a request for posterior t.i.

Next, in step 102c, the server collates from a database t.i. by a posterior time.

In step 103, the server delivers the t.i. to the client.

Then, in step 104c, the client appends a t.i. sequence.

In step 105c the client then displays the t.i. below its latest instance.

In step 106c, path (c) terminates.

The procedure for path (d) is invoked by upwards traversal.

First, in step 101, a client issues a request for anterior t.i.

Next, in step 102d, the server collates from a database t.i. by an anterior time.

In step 103, the server delivers the t.i. to the client.

Then, in step 104d, the client prepends a t.i. sequence.

In step 105d, the client then displays the t.i. above its earliest instance.

Last, in step 106d, path (d) terminates.

FIGS. 2A-2H depict various example displays of temporal sequences and indicate events for traversing them. Visible to a user are the dates and times presented and accompanying text not featured. Such text may, e.g., describe what is happening on a given date and time. A temporal sequence, as discussed herein, is a chronological list of temporal information, possibly including a date and time and accompanying text describing what is happening then.

Referring now to FIG. 2A in more detail, a user generates an event on an indicium at a client device, invoking FIG. 1 path (a). An event includes, e.g., a gesture applied to a device such as a keystroke input, a touchpad gesture, or the like. In this example, t.i. instances from last Sunday at 2:25pm to this Friday at 3:35pm are supplied to the client for access and storage. By step 106a of FIG. 1, in which the client positions its display towards a non-endpoint of the t.i., “today at 3:05pm” and “tomorrow at 3:10pm” and their accompanying text populate the display of the client device. T.i. instances below and above are hidden.

The user then traverses upwards to view t.i. instances from last Sunday at 2:25pm to today at 2:50pm; the user subsequently traverses downwards to view t.i. instances from this Thursday at 3:20pm to this Friday at 3:35pm. Such traversals invoke paths (d) and (c) of FIG. 1, prepending August 31^{st}—last Sunday at 2:15pm and appending this Friday at 3:45pm—October 1^{st}, 12:00pm at the client.

Conditions for the possibility of viewing specific instances of t.i. are specified on the right side of FIG. 2A, in the tables of FIG. 2B, and in the specification of FIG. 2C. In FIG. 2A, as indicated by its corresponding marks, the t.i. instance “last Sunday at 2:25pm” is indexed by 0, “October 1st, 12:00pm” by −1, and “August 31st, 11:00am” by 8. The other t.i. instances, in this figure and the others with temporal sequences, are similarly indexed by integers. Reaching t.i. instances with indices
less than 0 requires upwards traversal and prepending,
from 0 to 2 requires upwards traversal,
from 6 to 7 requires downwards traversal,
greater than 7 requires downwards traversal and appending.

In the rightmost column of the first row of each of its tables, FIG. 2A specifies ranges of indices i (given above) for t.i. instances t, below encoding answers to yes-or-no questions about their reachability with T and ⊥. The diamond modality indicates the possibility of reaching some t; the box modality indicates the necessity of reaching some t. The non-rightmost columns of the first rows of the tables mark events for reaching t.i., below encoding answers to yes-or-no questions about whether the events arose with T and ⊥. FIG. 2C gives this specification in a different way.

FIG. 2D depicts hour- and minute-controller indicia. A user generates an event on the indicia for 7:40pm, invoking FIG. 1 path (b). As a consequence, as illustrated in FIG. 2E, t.i. instances from 6:55pm to 8:10pm are supplied to the client for access and storage. By step 106b, t.i. instances for 7:30pm through 7:35pm populate the display of the client. The user traverses upwards to view t.i. instances from 6:55 to 7:20pm; the user traverses downwards to view t.i. instances from 7:45 to 8:10pm. Such traversals invoke paths (d) and (c) of FIG. 1, prepending t.i. instances from 5:30 to 6:35 pm appending t.i. instances from 8:35 to 11:15pm at the client.

FIG. 2F depicts a calendar. On January 15th, a user generates an event on January 18th, the following Wednesday. As a consequence, as illustrated in FIG. 2G, t.i. instances from the following Tuesday at 8:45pm to the following Thursday at 9:30am are supplied to the client. By step 106b, t.i. instances for the following Wednesday at 11:45am and 3:30pm populate the display of the client. The user traverses upwards to view t.i. instances for the following Tuesday at 8:45pm through the following Wednesday at 10:30am; the user traverses downwards to view t.i. instances for the following Wednesday at 7:30pm through the following Thursday at 9:30am. Such traversals invoke paths (d) and (c) of FIG. 1, prepending t.i. instances from the following Monday at 8:40pm to the following Tuesday at 8pm and appending t.i. instances from the following Thursday at 10:30am to the following Friday at 7:45am at the client.

FIG. 2F illustrates the possibility of non-sorted (but similar) sequences of t.i. Such sequences of t.i. may arise in virtue of some non-temporal notion of priority, and they will appear liberally in subsequent figures.

Additional examples are illustrated in FIGS. 3A-5H.

FIGS. 3A-3C show examples of temporal information traversed by a present time. Each t.i. instance in FIG. 3B is on a present date, and those in FIGS. 3A and 3C are on various dates.

FIGS. 4A-4B present hour- and minute-controller indicia for reaching t.i. by a specified time. FIGS. 4C-H depict hour- and minute-controller indicia and temporal sequences resulting from events on them. FIG. 4C illustrates user-generated events on hour- and minute-controller indicia for 7:50am, and FIG. 4D illustrates a resulting t.i. sequence. FIG. 4E illustrates user-generated events on indicia for 2:45pm, and FIG. 4F illustrates a resulting t.i. sequence. FIG. 4G illustrates user-generated events on indicia for 10:20pm, and FIG. 4H illustrates a resulting t.i. sequence.

FIGS. 5A-5B show calendars for reaching t.i. FIGS. 5C-H depict such calendars and also temporal sequences that result from events on them. In particular, t.i. by August 12^{th} and by this Wednesday and last Tuesday relative to some date is shown. The t.i. sequences are traversed in the manner discussed earlier.

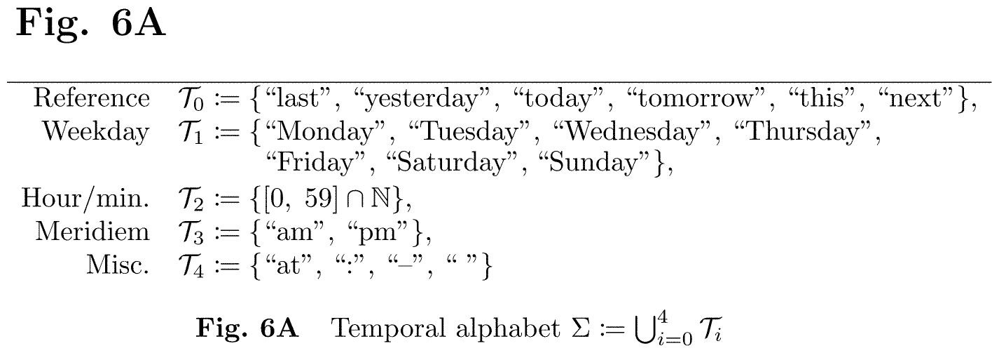

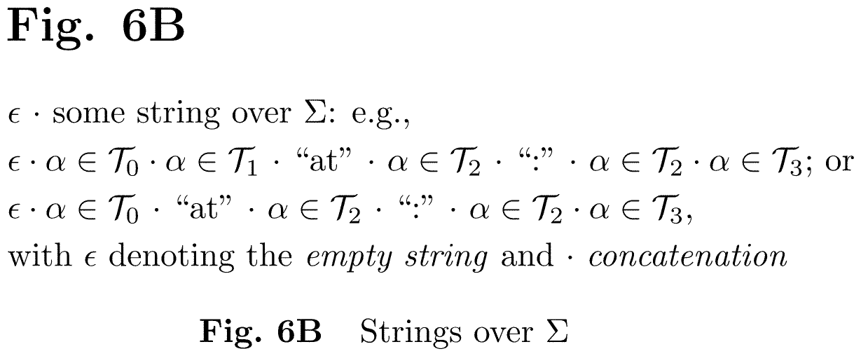

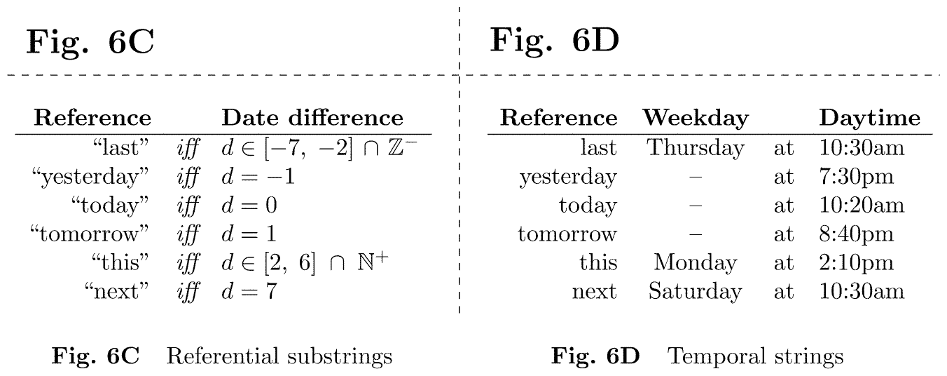

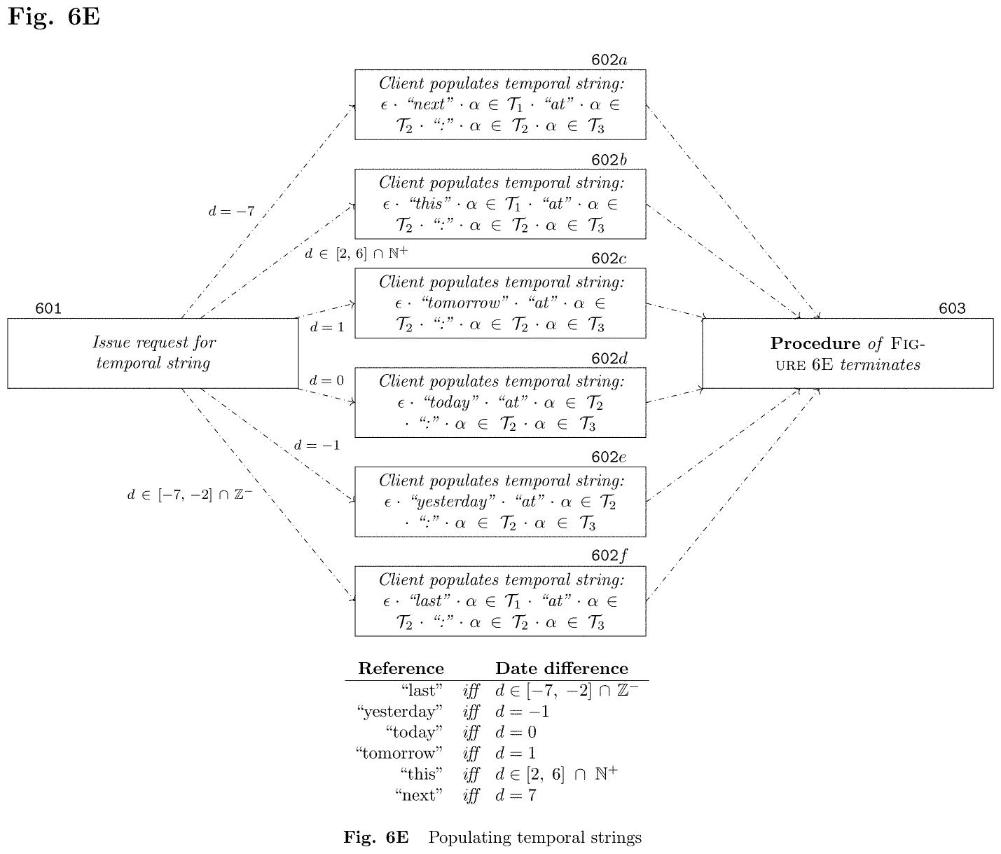

FIG. 6A introduces an example temporal alphabet. FIG. 6B gives the form of possible strings over the alphabet, with FIG. 6D giving concrete strings. FIG. 6C indicates how temporal strings are populated with references to a present date.

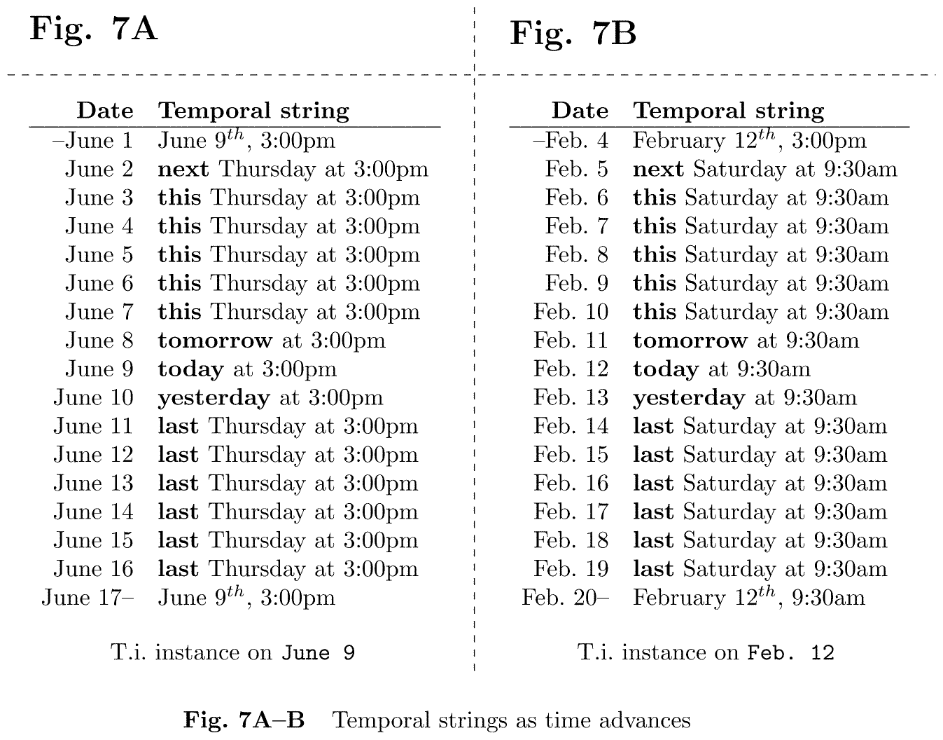

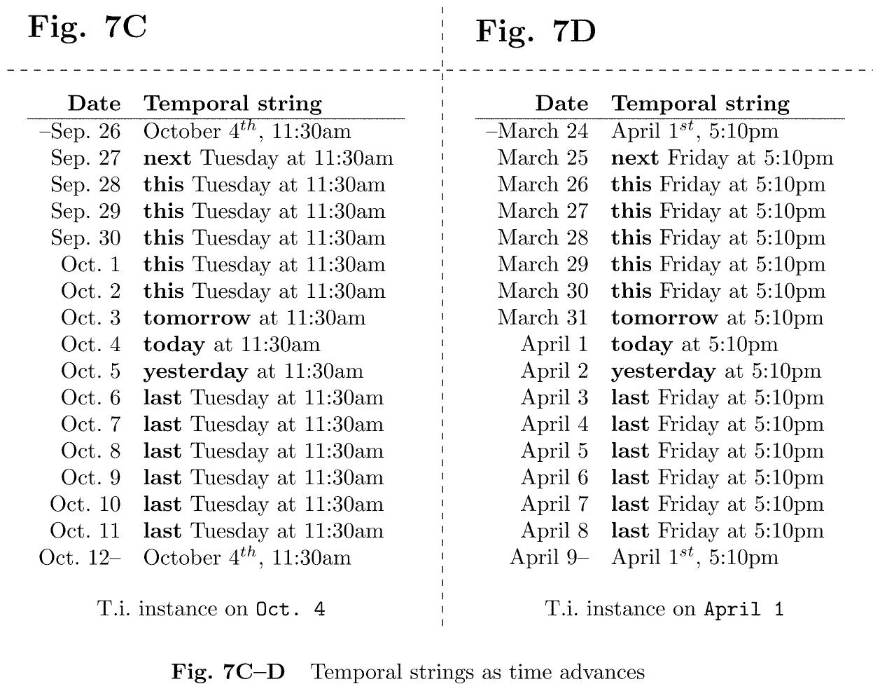

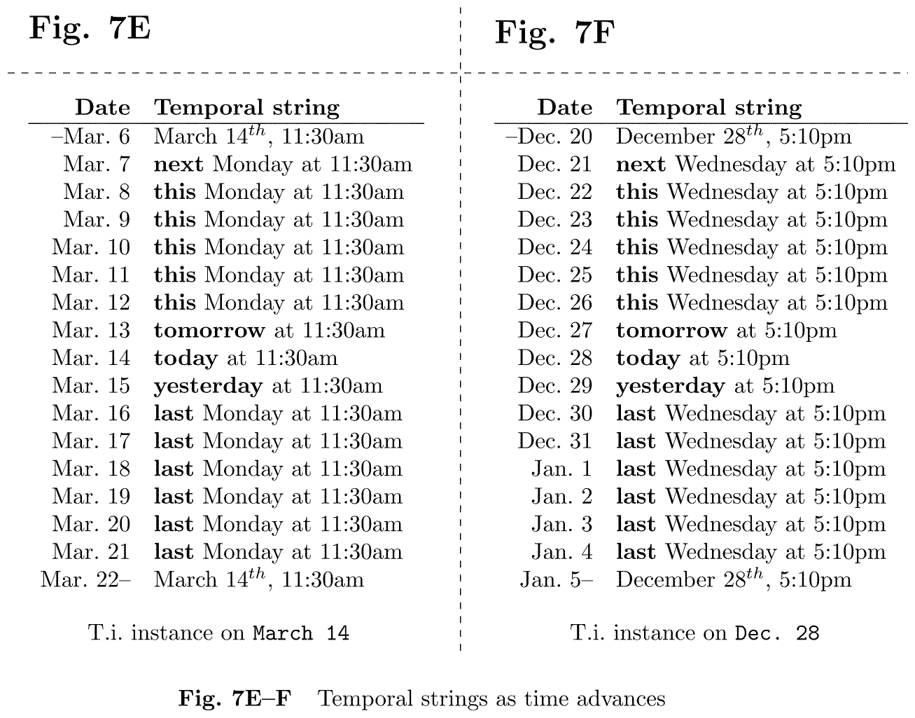

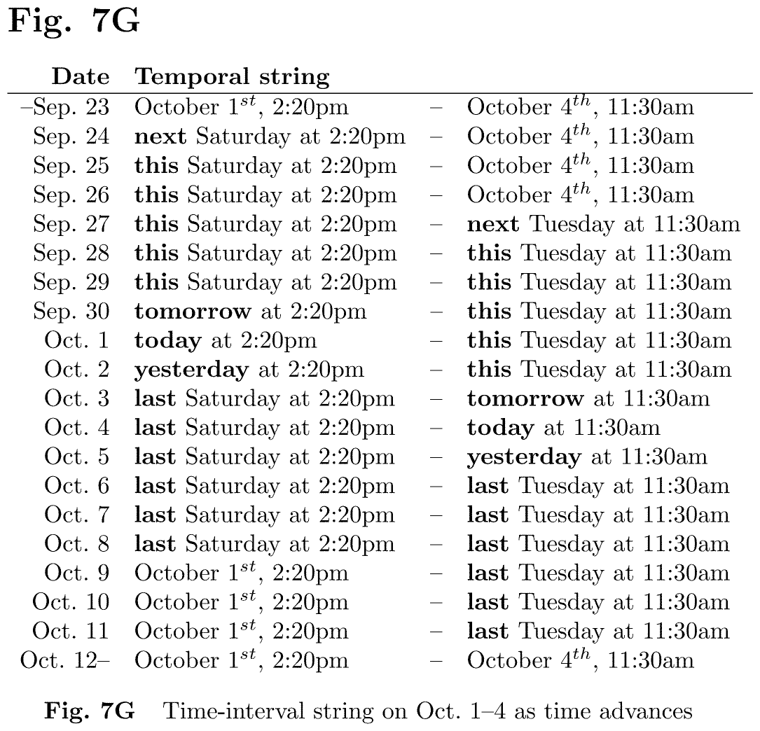

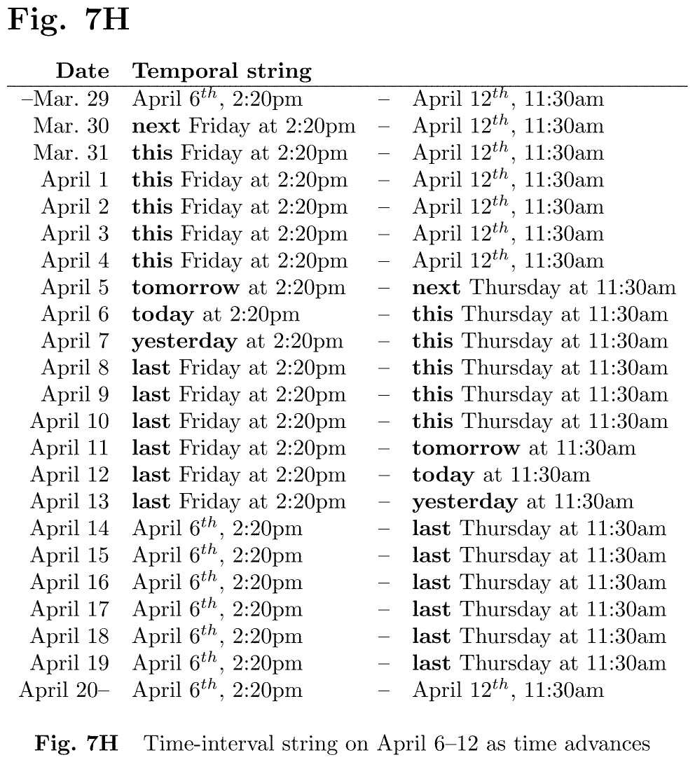

FIGS. 7A-7I illustrate the evolution of temporal strings as time advances. Referential words, written in bold, evolve in accordance with the specification of FIG. 6C. The process flow of FIG. 6E reflects this evolution, giving the form of possible strings in accordance with the date difference between a present date and the date of a t.i. instance.

The evolution of a temporal string for a t.i. instance on June 9 is shown in FIG. 7A. A user reads from a graphical user interface “next Thursday at 3:00pm” on June 2, “this Thursday at 3:00pm” on June 3-7, “tomorrow at 3:00pm” on June 8, “today at 3:00pm” on June 8, “yesterday at 3:00pm” on June 10, and “last Thursday at 3:00pm” on June 11-16. Presenting the string dynamically in this manner improves the user's comprehension of it.

FIG. 7B illustrates the evolution of a temporal string on February 12. FIG. 7c illustrates the evolution of a temporal string on October 4. FIG. 7D illustrates the evolution of a temporal string on April 1. FIG. 7E illustrates the evolution of a temporal string on March 14. FIG. 7F illustrates the evolution of a temporal string on December 28. FIG. 7G illustrates the evolution of a temporal string on October 1-4. FIG. 7H illustrates the evolution of a temporal string on April 6-12. FIG. 7I illustrates the evolution of a temporal string on November 22-3.

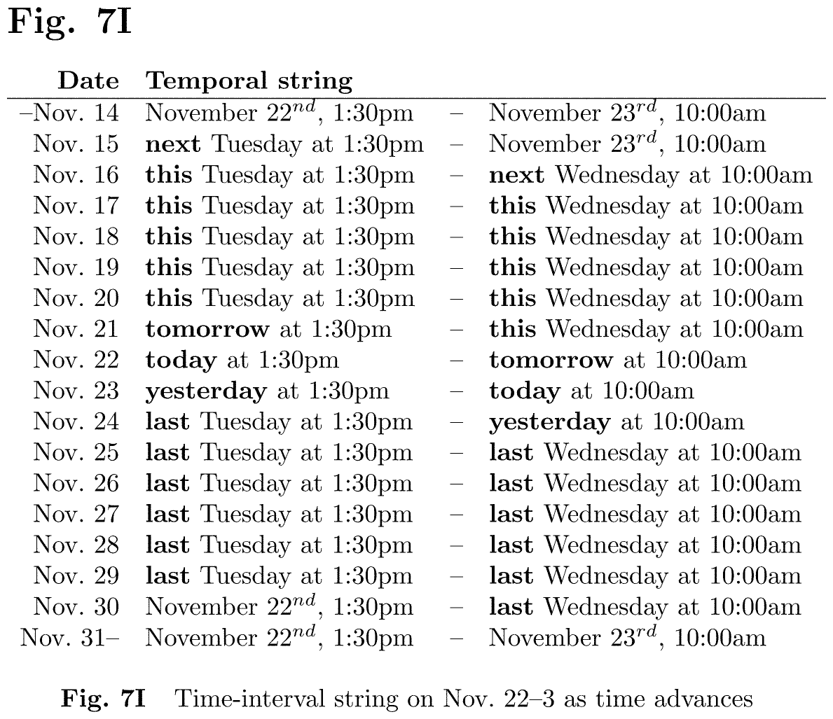

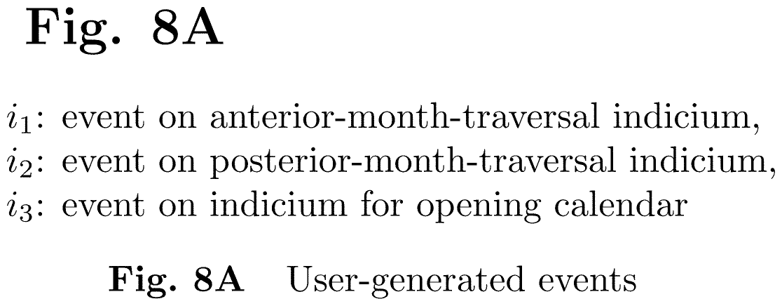

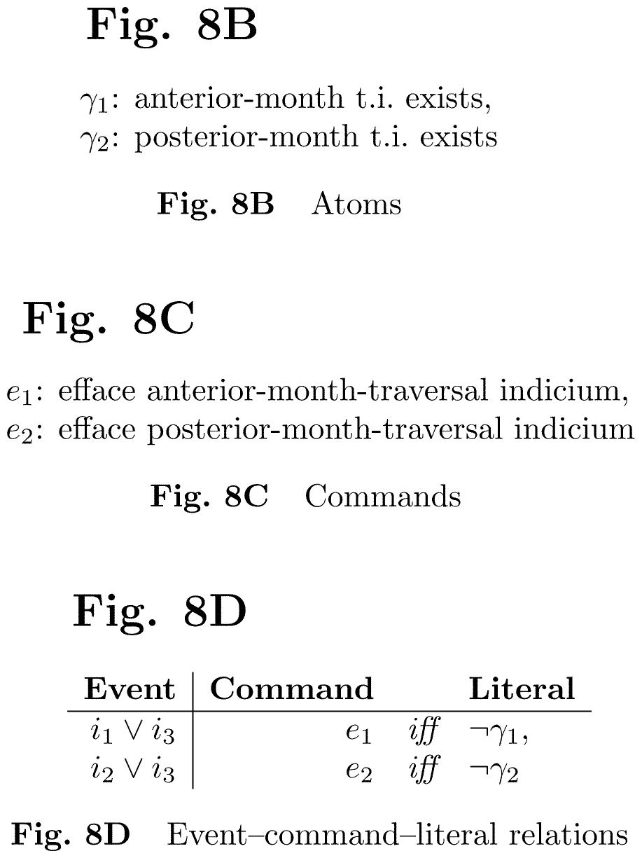

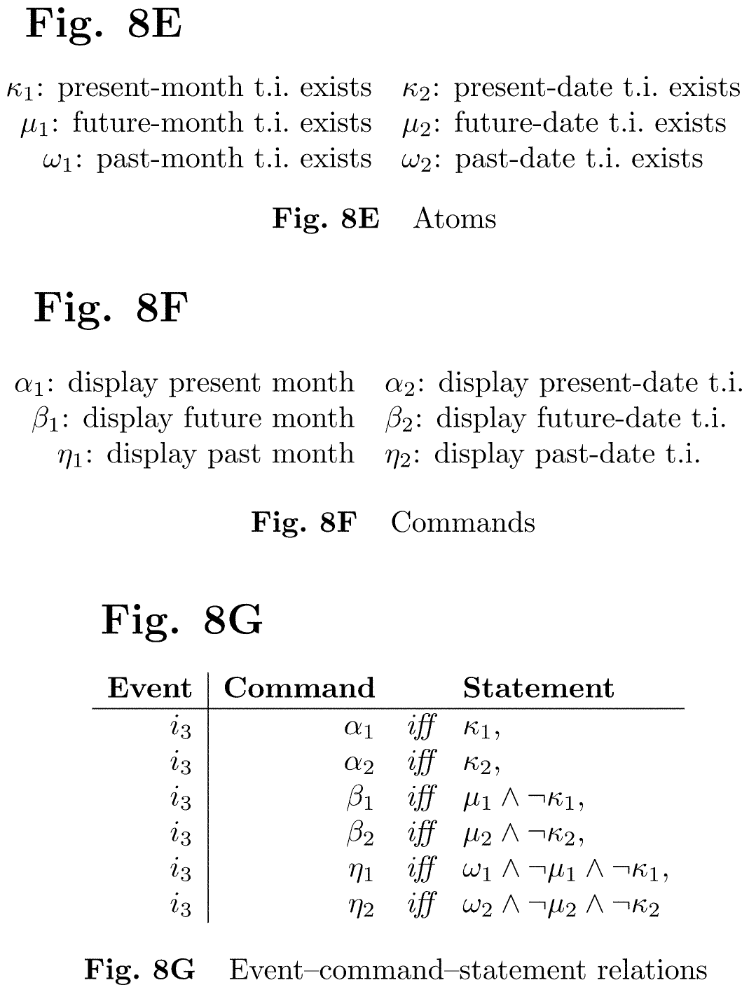

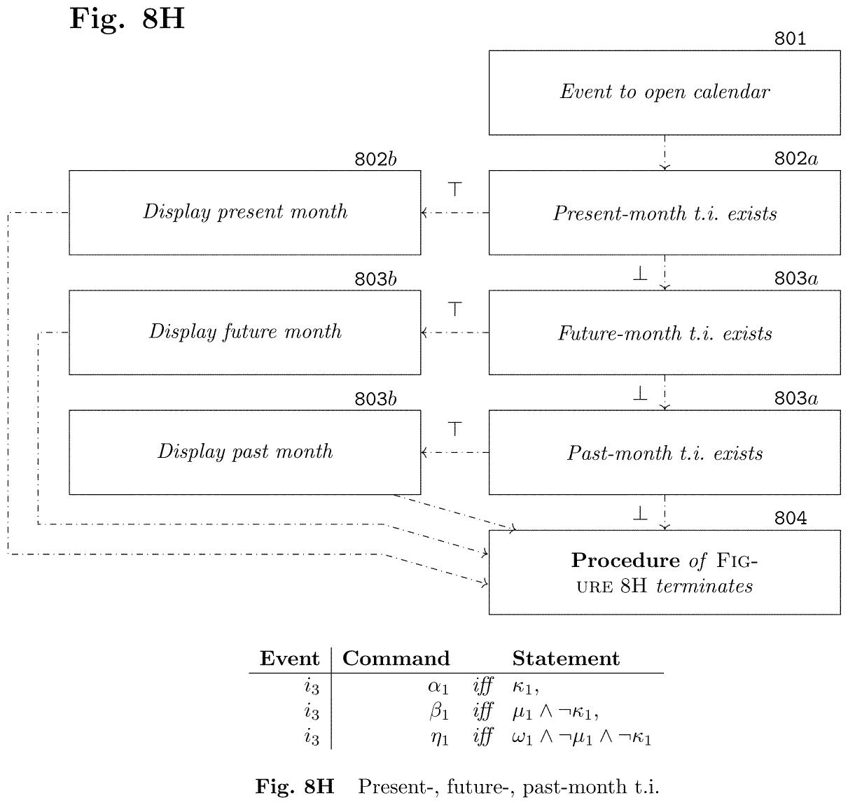

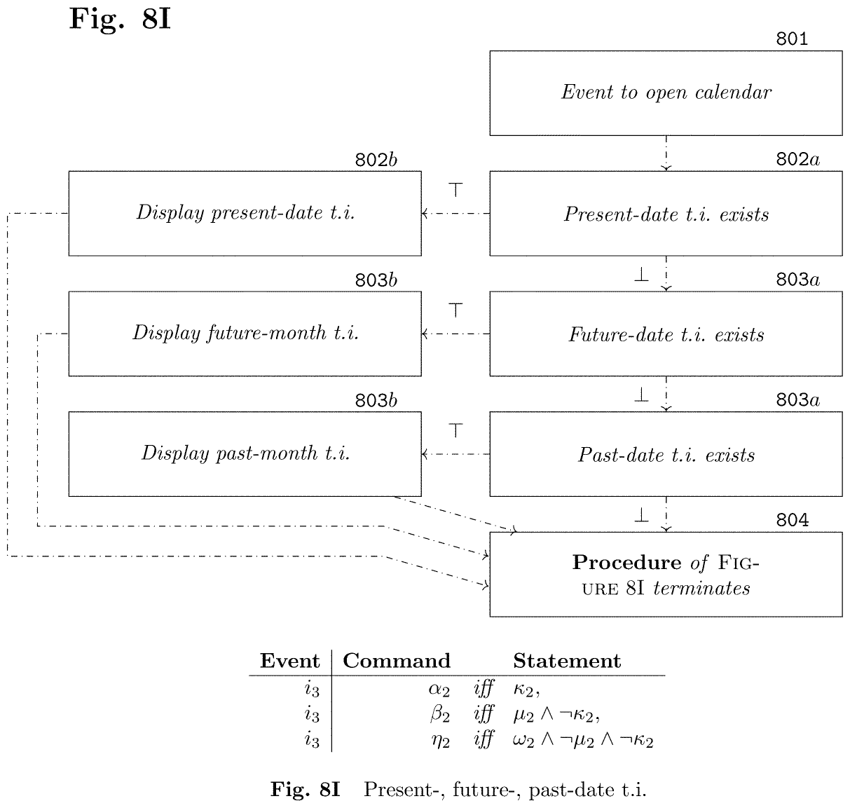

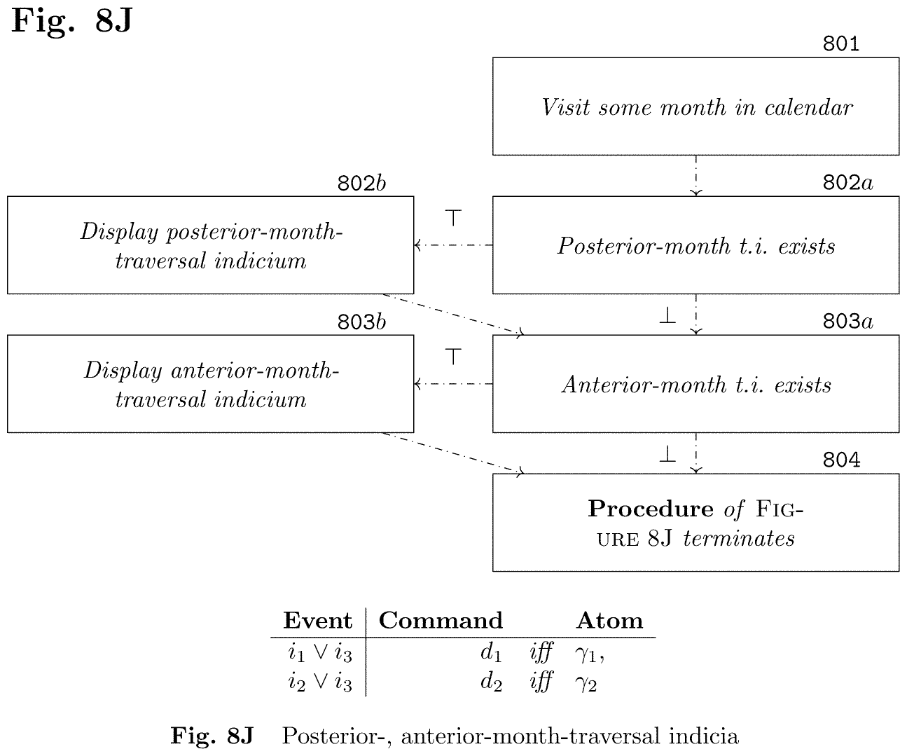

FIG. 8A labels example user-generated events for opening and traversing calendars (e.g., i₁). FIG. 8B labels atoms and FIG. 8C labels commands involved in manipulating anterior- and posterior-month-traversal indicia of calendars.

FIG. 8D specifies example relations between the user-generated events, atoms, and commands. These relations spell out precise conditions for populating calendars with temporal information. In particular, FIG. 8D involves the following example relations:
in response to an event to open a calendar or on an anterior-month-traversal indicium, display said indicium iff there exists anterior-month t.i.;
in response to an event to open a calendar or on a posterior-month-traversal indicium, display said indicium iff there exists posterior-month t.i.

FIGS. 8H-8J illustrate procedures related to FIGS. 8A-8G.

More particularly, FIG. 8H includes the following steps.
An event to open a calendar is processed by a client in step 801.
If present-month t.i. exists (state 802a—true), the client displays a present month and the procedure terminates; otherwise (state 802a—false), the client steps towards 803a.

If future-month t.i. exists (state 803a—true), the client displays a future month and the procedure terminates; otherwise (state 803a—false), the client steps towards state 804a.

If past-month t.i. exists (state 803a—true), the client displays a past month and the procedure terminates; otherwise (state 803a—false), the procedure immediately terminates.

FIG. 8I includes analogous steps to those of FIG. 8H with respect to present-date t.i. In this example, t.i. that likely is of greatest interest to a user therefore is prioritized.

FIG. 8J includes example steps of processing some event to visit some month in a calendar; and displaying posterior- and anterior-month-traversal indicia iff there exists posterior- and anterior-month t.i., respectively.

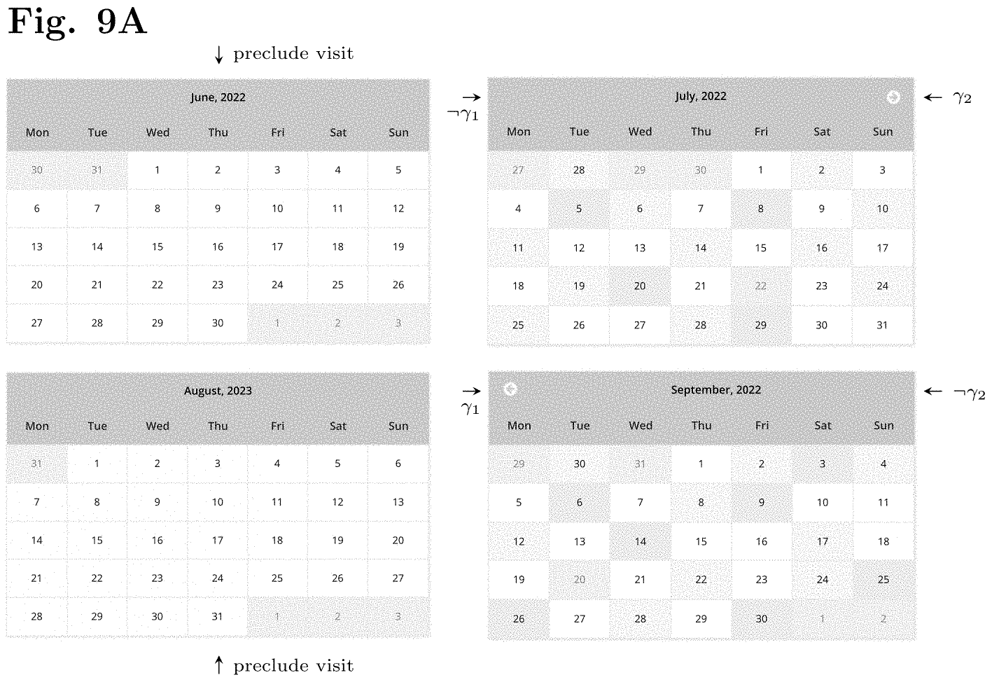

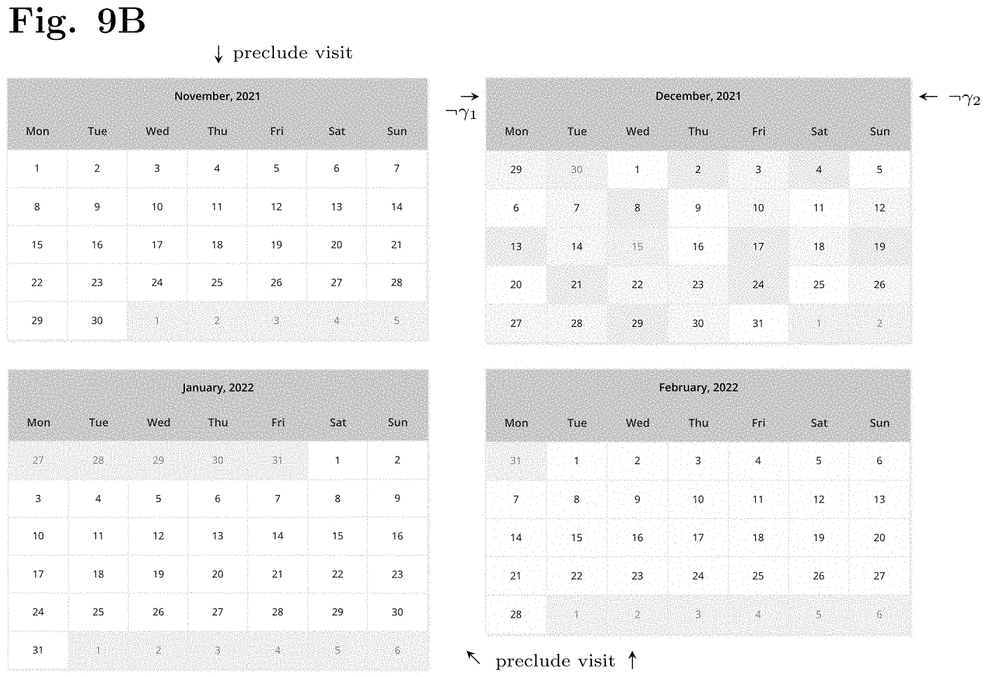

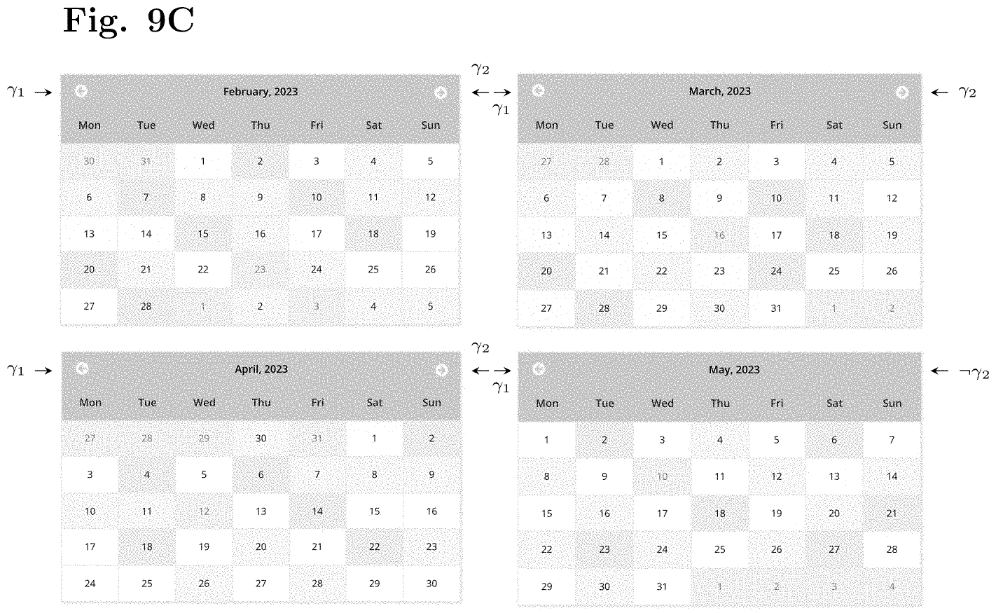

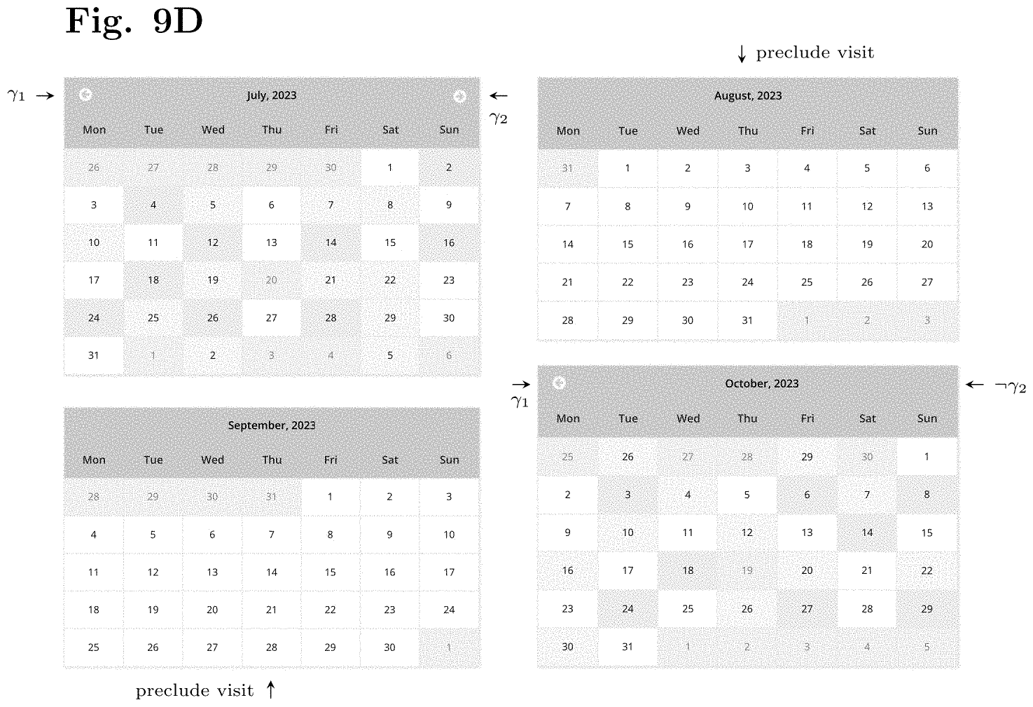

FIGS. 9A-9D depict calendars marked with literals from FIG. 8B that engender (in light of the relations specified in FIG. 8D) the anterior- and posterior-month-traversal indicia they feature. They furthermore note that traversal towards months without t.i. is precluded.

The two atoms in FIG. 8B and commands in FIG. 8C are respectively evaluated and possibly executed upon visiting an arbitrary month within the scope of the calendar via any of the three user-generated events labeled in FIG. 8A.

FIG. 8E labels atoms and FIG. 8F commands involved in presenting t.i. in response to the opening of a calendar. FIG. 8G specifies relations between statements and the commands: in order of priority, (a) a present, future, or past month and (b) present-, future-, or past-date t.i. are displayed.

Four months are depicted in FIG. 9A, with only one at a time visible from the perspective of a user. In view of July, the anterior-month-traversal indicium is hidden and the user is therefore barred from traversal towards anterior months. As indicated by its corresponding mark, there is not t.i. anterior to July. The posterior-month-traversal indicium is presented, permitting the user to traverse towards a posterior month. The user generates an event on this indicium to supersede July with September, skipping August for its lack of t.i. September's anterior- and posterior-month-traversal indicia are respectively presented and hidden for analogous reasons.

In FIG. 9B, a user can view only the month of December, and anterior- and posterior-month-traversal indicia are hidden: t.i. is only on this month. In FIG. 9C, a posterior-month-traversal indicium is hidden for the month of May, because there is no temporal information posterior to that month. In FIG. 9D, there is no such mark on the month of October for the same reason. A user traverses from October to July and back, skipping August and September for their lack of t.i.

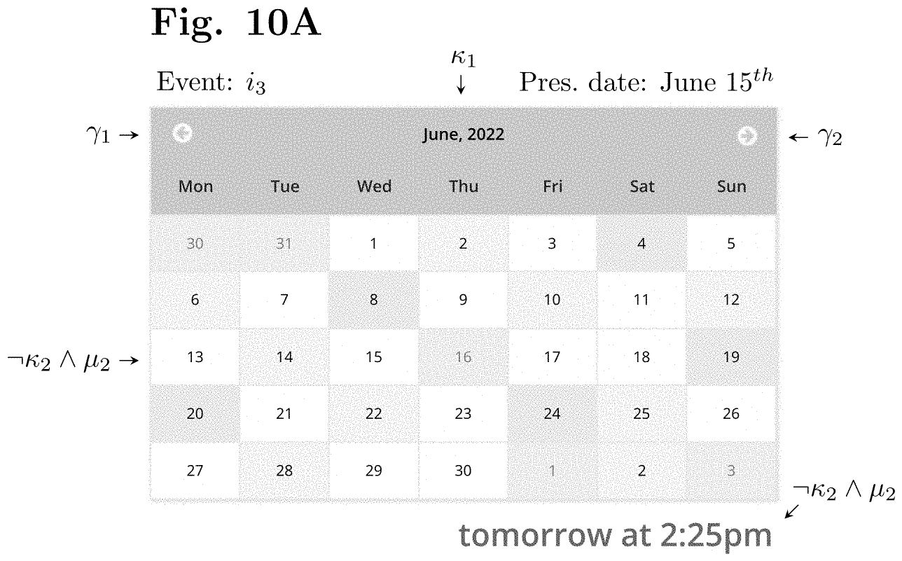

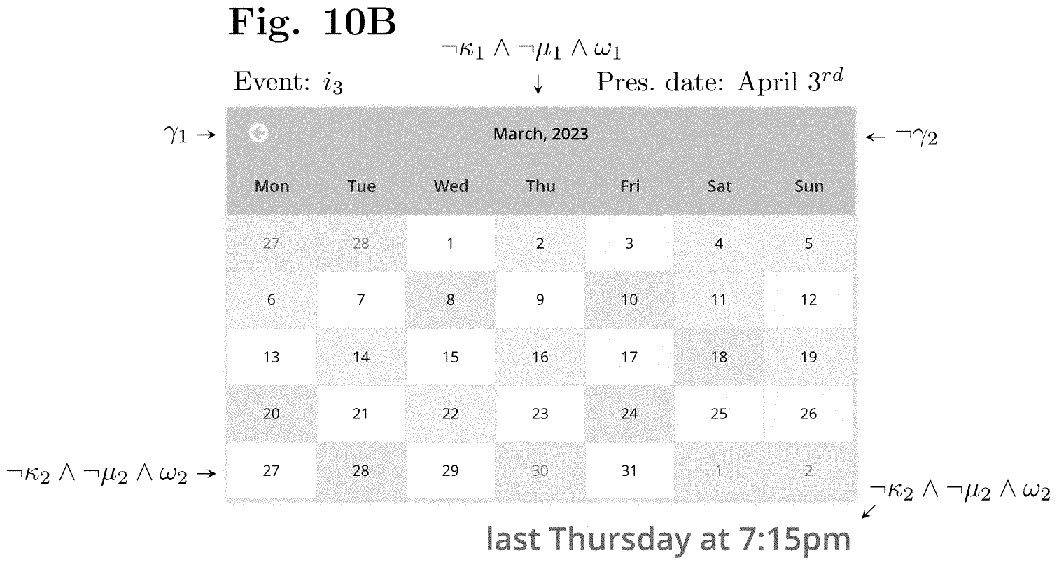

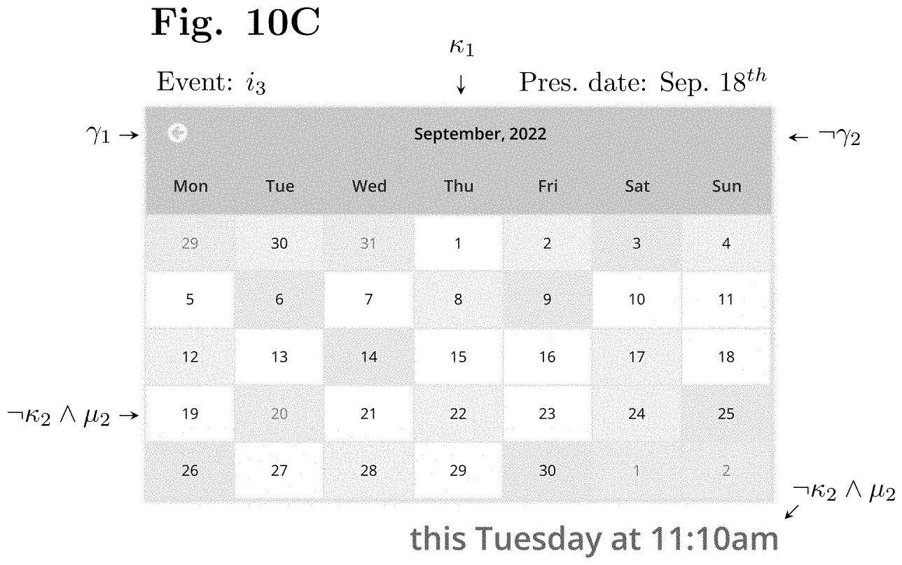

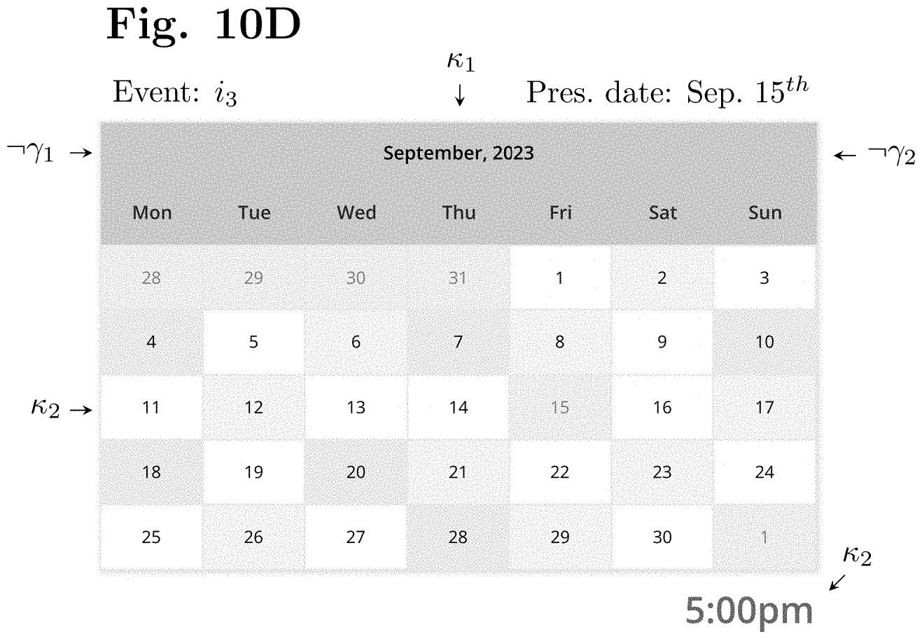

FIGS. 10A—10D depict newly-opened calendars marked with various statements. The calendar in FIG. 10A features t.i. following a user-generated event to open a calendar. A present date is indicated towards its top-right corner. A present month is displayed to a user of a client device due to t.i. on it. Its anterior- and posterior-month-traversal indicia are both presented for anterior- and posterior-month t.i. exist. Displayed below the calendar is “tomorrow at 2:25pm” and accompanying text: there is not present-date t.i.; there is future-date t.i.

FIG. 10B features t.i. on a past month and date, and anterior- and posterior-month-traversal indicia are respectively shown and hidden. This temporal information presented can be inferred from its corresponding marks.

FIGS. 10C and 10D are still further examples of calendars and example statement markings.

### IMPLEMENTATION OPTIONS

It should be understood that the example embodiments described herein may be implemented in many different ways. The embodiments may be implemented by data processors located within personal or laptop computers, servers, smartphones, tablets, mobile devices, embedded machines, and other computer systems. In some instances, the various “data processors” may each be implemented by a physical or virtual general-purpose computer having a central processor, memory, disk or other mass storage, communication interface(s), input/output (I/O) device(s), and other peripherals. The general-purpose computer is transformed into the processors and executes the methods described herein, for example, by loading software instructions into the computer, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., one or more central processing units, disks, various memories, input/output ports, network ports, etc.) that enables the transfer of information between the elements. One or more central processor units are attached to the system bus and provide for the execution of computer instructions. Also attached to the system bus are typically I/O device interfaces for connecting the disks, memories, and various input and output devices. Network interface(s) allow connections to various other devices attached to a network. One or more memories provide volatile and/or non-volatile storage for computer software instructions and data used to implement an embodiment. Disks or other mass storage provides non-volatile storage for computer software instructions and data used to implement, for example, the various procedures described herein.

Embodiments may therefore typically be implemented in hardware, custom designed semiconductor logic, Application Specific Integrated Circuits (ASICs), Field Programmable Gate Arrays (FPGAs), firmware, software, or any combination thereof.

In certain embodiments, the procedures, devices, and processes described herein are a computer-program product, including a computer-readable medium (e.g., a removable storage medium such as one or more DVD-ROMs, CD-ROMs, diskettes, tapes, etc.) that provides at least a portion of the software instructions for the system or the method. Such a computer-program product can be installed by any suitable software installation procedure, as is well known in the art. In another embodiment, at least a portion of the software instructions may also be downloaded as application software over a cable, communication network, and/or wireless connection from a server to a smartphone, laptop, personal computer, tablet, or other data-processing device.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read-only memory (ROM); random-access memory (RAM); storage including magnetic disk storage media; solid state drives; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc. It also should be understood that the block and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

The above description has particularly shown and described example embodiments. However, it will be understood by those skilled in the art that various changes in form and details may be made therein without departing from the legal scope of this patent as encompassed by the appended claims.

1. A client—server system, comprising:
a client- and server-side processor; and
a client- and server-side non-transient machine-readable memory with instructions executed by its processor to traverse temporal information in response to user input, the operations comprising:
allocating from the server for access by the client a collection of temporal information by a present time in response to an event on an indicium occurring at the client;
populating, on a display of the client, a sequence of the temporal information;
positioning the display of the sequence of temporal information towards a non-endpoint of the temporal information, permitting upwards and downwards traversal of the sequence of temporal information from the position by a user of the client;
in response to the downwards traversal, appending to the display of the sequence of temporal information a chronological sequence of posterior temporal information supplied by the server; and
in response to the upwards traversal, prepending to the display of the sequence of temporal information a chronological sequence of anterior temporal information supplied by the server.

2. The system as recited in claim 1, wherein the collection of temporal information allocated from the server depends on a present time.

3. The system as recited in claim 1, wherein the collection of temporal information allocated from the server towards a client depends on a user-specified time other than a present time.

4. The system as recited in claim 1, wherein the collection of temporal information allocated from the server towards a client is by a user-specified calendar date other than a present time.

5. A system for handling temporal information, comprising:
two or more processors, including at least one at a server and one at a client; and
one or more non-transient, computer readable media storing instructions that, when executed by the one or more processors, cause the one or more processors to perform a process a to populate a calendar at the client with temporal information supplied by the server in response to user input at the client, the process comprising:
in response to an event on an indicium at the client to open a calendar,
displaying a present month if there is server-supplied temporal information for the present month, and
displaying a future or past month otherwise;
in response an event for posterior- or anterior-month traversal,
skipping one or more months barring server-supplied temporal information on them;
upon the user visiting an arbitrary month within the scope of the calendar, featuring an indicium for traversal towards a posterior month if and only if there is server-supplied temporal information on such a month; and
upon the user visiting an arbitrary month within the scope of the calendar, featuring an indicium for traversal towards an anterior month if and only if there is server-supplied temporal information on such a month.

6. The system as recited in claim 6, wherein process further comprises,
in response to the event on an indicium at the client to open a calendar,
displaying outside the calendar temporal information on a present date if there is temporal information on it, and displaying outside the calendar future- or past-date temporal information otherwise.

7. A client device for handling temporal information, comprising:
a processor; and
a non-transient machine-readable memory with instructions executed by the processor to populate the contents of a temporal string in accordance with a date difference between a present date and a date of a temporal-information instance, the operations comprising:
(a) populating the temporal string with a “next” label followed by a weekday label when a date difference between a present date and a date of the temporal string's corresponding temporal-information instance is a value that represents −7;
(b) populating the temporal string with “this” followed by a weekday when said date difference is a value that represents a number between −6 and −2;
(c) populating the temporal string with “tomorrow” when said date difference is a value that represents −1;
(d) populating the temporal string with “yesterday” when said date difference is a value that represents 1; and
(e) populating the temporal string with “last” followed by a weekday when said date difference is a value that represents a number between −2 and −7.

8. The system as recited in claim 6, wherein at least three of (a)-(e) are true for the temporal string.
